(19) United States
(12) Patent Application Publication
(10) Pub. No.: US 2025/0264381 A1
(43) Pub. Date: Aug. 21, 2025

(54) SYSTEMS AND METHODS FOR CONTROLLED COLLECTION AND INJECTION OF PLUME-GENERATED AEROSOLS INTO ANALYTIC DEVICES

(71) Applicant: POINT SURGICAL INC., TORONTO (CA)

(72) Inventors: SUBHA CHAKRABORTY, ETOBICOKE (CA); ARASH ZARRINE-AFSAR, TORONTO (CA); DARREN KRAEMER, TORONTO (CA)

(21) Appl. No.: 18/857,215

(22) PCT Filed: Apr. 17, 2023
(86) PCT No.: PCT/CA2023/050518

§ 371 Date: Oct. 16, 2024

Related U.S. Application Data
(60) Provisional application No. 63/332,247, filed on Apr. 18, 2022.

(51) Int. Cl. G01N 1/22; G01N 1/00; H01J 49/00; H01J 49/04

(52) U.S. Cl. CPC G01N 1/2202; H01J 49/0031; H01J 49/0431; H01J 49/0468; G01N 2001/002; G01N 2001/2223

(57) ABSTRACT

Systems and method are disclosed that facilitate the controlled collection an aerosol sample from an aerosol plume and the controlled injection of the aerosol sample into an analysis device such as a mass spectrometer. The disclosed embodiments decouple the aerosol sample collection process from the aerosol sample injection process via the use of an intermediate collection chamber, into which an aerosol sample is collected from an aerosol plume prior to injection into an analytic device. In some embodiments, temporal coordination is provided between the generation of the aerosol plume and the collection of an aerosol sample from the aerosol plume into an intermediate chamber, with optional incubation in the intermediate chamber prior to injection. The disclosed systems and methods have been found to facilitate a reduction in the temporal variations (stability) and/or the spatial inhomogeneity of the composition of the aerosol sample that is injected into the analytic device.

### CROSS-REFERENCE TO RELATED APPLICATION

This application claims priority to U.S. Provisional Patent Application No. 63/332,247, titled “SYSTEMS AND METHODS FOR CONTROLLED COLLECTION AND INJECTION OF PLUME-GENERATED AEROSOLS INTO ANALYTIC DEVICES” and filed on Apr. 18, 2022, the entire contents of which is incorporated herein by reference.

### BACKGROUND

The present disclosure relates to the analysis of aerosols. In particular, the present disclosure relates to collection of aerosol samples from aerosol plumes and the delivery of aerosol samples to analytic devices such as mass spectrometers.

Ambient mass spectrometry analysis, in which aerosolization of specimens to be analyzed takes place under ambient atmospheric conditions, has grown to be an extremely useful analytic method in evaluating the molecular composition of aerosols, with application domains in environmental and clinical sciences among others. According to conventional ambient mass spectrometry methods, an aerosol is transferred to a mass spectrometer, for example, using an on-line transfer tube, with an injection rate dictated by the inherent suction of the mass spectrometer pump.

### SUMMARY

Systems and method are disclosed that facilitate the controlled collection an aerosol sample from an aerosol plume and the controlled injection of the aerosol sample into an analysis device such as a mass spectrometer. The disclosed embodiments decouple the aerosol sample collection process from the aerosol sample injection process via the use of an intermediate collection chamber, into which an aerosol sample is collected from an aerosol plume prior to injection into an analytic device. In some embodiments, temporal coordination is provided between the generation of the aerosol plume and the collection of an aerosol sample from the aerosol plume into an intermediate chamber, with optional incubation in the intermediate chamber prior to injection. The disclosed systems and methods have been found to facilitate a reduction in the temporal variations (stability) and/or the spatial inhomogeneity of the composition of the aerosol sample that is injected into the analytic device.

Accordingly, in one aspect, there is provided a method of performing mass spectrometry on a collected aerosol, the method comprising:
employing an aerosol generating device to generate an aerosol plume from a material;
during and/or after generation of the aerosol plume by the aerosol generating device, collecting, via suction generated by a pump, an aerosol sample into a chamber, such that collection of the aerosol sample is temporally controlled relative to the generation of the aerosol plume, the aerosol sample comprising at least a portion of the aerosol plume;
bringing the chamber into fluidic communication with an inlet of a mass spectrometer; and
injecting the aerosol sample from the chamber to the mass spectrometer.

In some example implementations of the method, a composition of the aerosol plume generated from the material varies with time during generation of the aerosol plume, and wherein the collection and the injection of the aerosol sample is configured such that during injection of the aerosol sample into the mass spectrometer, a composition of the injected aerosol sample is substantially constant.

In some example implementations of the method, a composition of the aerosol plume generated from the material is spatially heterogeneous, and wherein the collection and the injection of the aerosol sample is configured such that during injection of the aerosol sample into the mass spectrometer, a composition of the aerosol sample is substantially homogeneous.

In some example implementations, the method further includes, after collecting the aerosol sample into the chamber, preventing fluid communication between the chamber and an external ambient environment for a dwell time interval before bringing the chamber into fluidic communication with the inlet of the mass spectrometer.

In some example implementations of the method, a time duration of collection of the aerosol sample is longer than a time duration of generation of the aerosol plume.

In some example implementations of the method, a time duration of collection of the aerosol sample is shorter than a time duration of generation of the aerosol plume.

In some example implementations of the method, a time duration of collection of the aerosol sample from the aerosol plume is longer than a time duration of injection of the aerosol sample into the mass spectrometer.

In some example implementations of the method, a time duration of collection of the aerosol sample from the aerosol plume is shorter than a time duration of injection of the aerosol sample into the mass spectrometer.

In some example implementations of the method, a volumetric rate of collection of the aerosol sample from the aerosol plume is different from a volumetric rate of injection of the aerosol sample into the mass spectrometer.

In some example implementations of the method, the mass spectrometer is remote from the aerosol generating device, and wherein the chamber is transported to the mass spectrometer during the dwell time interval.

In some example implementations of the method, the chamber is in fluid communication with a fluidic conduit, the fluidic conduit comprising a distal port, wherein the fluidic conduit is movable such that: during collection of the aerosol sample, the distal port resides proximal to a location of generation of the aerosol plume; and during injection of the aerosol sample, the distal port resides proximal to the inlet of the mass spectrometer.

In some example implementations of the method, the aerosol plume is generated at least 1 m from the inlet of the mass spectrometer, and wherein an intrinsic intake rate of the mass spectrometer would be insufficient to directly sample the aerosol plume through a conduit extending between the aerosol plume and the inlet of the mass spectrometer.

In some example implementations of the method, a timing of injection of the aerosol sample is synchronized with the initiation of data acquisition of the mass spectrometer.

In some example implementations of the method, the mass spectrometer is configured to scan a mass range during a scan time, and wherein a time duration of injection of the aerosol sample is approximately equal to the scan time.

In some example implementations of the method, the mass spectrometer is configured to scan a mass range at a prescribed a duty cycle, and wherein the injection of the aerosol sample configured to occur during an active portion of the duty cycle.

In some example implementations of the method, the pump is controlled to inject of the aerosol sample from the chamber to the mass spectrometer.

In some example implementations of the method, injection of the aerosol sample into the mass spectrometer is facilitated by intrinsic suction of the mass spectrometer.

In some example implementations of the method, the pump is configured to generate suction for collection of the aerosol sample by increasing a volume of the chamber. The pump may be a syringe pump.

In some example implementations of the method, the chamber is in fluidic communication with a first fluidic conduit and a second fluidic conduit, wherein the first fluidic conduit comprises a first distal port located proximal to a location of generation of the aerosol plume, and wherein the second fluidic conduit comprises a second distal port located proximal to the inlet of the mass spectrometer, and wherein a first valve is provided to control fluid communication between the chamber and the first distal port, and wherein a second valve is provided to control fluid communication between the chamber and the second distal port; wherein the first valve is opened and the second valve is closed during collection of the aerosol sample from the aerosol plume; and wherein the first valve is closed and the second valve is opened during injection of the aerosol sample into the mass spectrometer.

In some example implementations of the method, the pump is a first pump, the chamber is a first chamber and the aerosol sample is a first aerosol sample, wherein a time duration of generation of the aerosol plume is longer than a time duration of collection of the first aerosol sample by the first pump, and wherein the first aerosol sample comprises a first portion of the aerosol plume, the method further comprising:
during and/or after generation of the aerosol plume by the aerosol generating device, actuating a second pump to collect a second aerosol sample into a second chamber, such that control of the second pump and collection of the second aerosol sample occurs after collection of the first aerosol sample by the first pump, the second aerosol sample comprising a second portion of the aerosol plume;
bringing the second chamber into fluidic communication with the inlet of the mass spectrometer; and
injecting the second aerosol sample from the second chamber to the mass spectrometer.

The second pump may be controlled to collect the second aerosol sample while injecting the first aerosol sample from the first chamber to the mass spectrometer.

The method may further comprise controlling the first pump to collect a third aerosol sample from the aerosol plume while injecting the second aerosol sample from the second chamber to the mass spectrometer.

In some example implementations, the method further includes employing a heater to heat the chamber.

In some example implementations, the method further includes, during collection of the aerosol sample, employing a sensor to measure a signal dependent on an amount of collected aerosol, the sensor being in fluid communication with the chamber.

In some example implementations, the method further includes controlling the pump for collection of the aerosol sample according to feedback from the sensor, such that the aerosol sample is collected until the signal satisfies pre-selected criteria.

The sensor may be configured such that the signal is dependent on humidity.

The sensor may be configured such that the signal is dependent on at least one of turbidity, optical absorptivity, optical spectroscopy, and light scattering.

In some example implementations, the chamber is in fluid communication with:
an inlet of the pump;
a first fluidic conduit; and
a second fluidic conduit;
wherein the first fluidic conduit comprises a first distal port located proximal to a location of generation of the aerosol plume, and wherein the second fluidic conduit comprises a second distal port located proximal to the inlet of the mass spectrometer, and wherein a first valve is provided to control fluid communication between the chamber and the first distal port, and wherein a second valve is provided to control fluid communication between the chamber and the second distal port;

wherein, prior to collection of the aerosol sample, the first valve and the second valve are closed and the pump is operated to generate a partial vacuum in the chamber; and

wherein collection of the aerosol sample from the aerosol plume is performed while operating the pump with the first valve in an open state and the second valve in a closed state.

Injection of the aerosol sample into the mass spectrometer may be facilitated, at least in part, by intrinsic suction of the mass spectrometer with the second valve in an open state.

The method may further include, after collecting the aerosol sample into the chamber, closing the first valve and the second valve to prevent fluid communication between the chamber and an external ambient environment for a dwell time interval.

The method may further include employing a pressure sensor in fluid communication with the chamber to measure a pressure signal dependent on a pressure within the chamber; and
prior to collection of the aerosol sample, monitoring the pressure signal while generating the partial vacuum; and
after determining that a sufficient partial vacuum has been established, controlling the aerosol generating device to initiate generation of the aerosol plume and opening the first valve to facilitate collection of the aerosol sample.

In some example implementations, the method further includes employing a pressure sensor in fluid communication with the chamber to measure a pressure signal dependent on a pressure within the chamber; monitoring the pressure signal during collection of the aerosol sample; and after determining that the pressure has reached atmospheric pressure, closing the first valve to prevent further collection.

In some example implementations of the method, the aerosol sample is injected in the absence of operation of the pump.

In some example implementations of the method, the pump is a bidirectional pump, and wherein the pump is operated in a first direction during collection of the aerosol sample, and wherein the pump is operated in a reversed direction during injection of the aerosol sample.

In some example implementations of the method, the pump is a first pump, and wherein a second pump resides inline with the second fluidic conduit and is operated during injection of the aerosol sample, in the absence of operation of the first pump.

In some example implementations of the method, the second fluidic conduit comprises a T-junction for facilitating the introduction of air with the aerosol sample during injection of the aerosol sample.

In some example implementations the method further includes providing a mass flow controller having an inlet in communication with a source of inert gas source and an outlet in fluid communication with the chamber; wherein the mass flow controller is controlled to inject the inert gas into the chamber at a controlled flow rate during injection of the aerosol sample.

The pump may be absent of operation during injection of the aerosol sample.

A third valve may reside between the chamber and the pump, wherein the third valve is closed during injection of the aerosol sample.

A third valve may reside between the chamber and the mass flow controller, wherein the third valve is closed during collection of the aerosol sample and opened during injection of the aerosol sample.

In some example implementations, the method further includes employing a heater to heat the chamber.

In some example implementations of the method, the heater is configured to provide sufficient heat to the chamber to maintain the aerosol sample in a dissolved state within the chamber.

In some example implementations of the method, the aerosol generating device is configured to generate the aerosol according to a modality selected from the group consisting of diathermy, ultrasonic aspiration, focused ultrasound, radiofrequency ablation, nebulization, laser desorption, laser ablation and photoacoustic drilling.

In some example implementations of the method, the aerosol plume is generated via absorption of infrared laser pulses having time duration between 1 ps and 1000 ps.

In some example implementations of the method, the pump is controlled such that collection of the aerosol sample is synchronous with the onset of formation of the aerosol plume by the aerosol generating device.

In some example implementations of the method, the pump is controlled such that collection of the aerosol sample from the aerosol plume is triggered according to a trigger signal received from the aerosol generating device.

In some example implementations of the method, a plume detection sensor is employed to generate a plume detection signal indicative of generation of the aerosol plume, and wherein the control of the pump for collection of the aerosol sample from the aerosol plume is triggered according to the plume detection signal.

In some example implementations of the method, injection of the aerosol sample into the mass spectrometer is performed in the absence of a pusher gas.

In some example implementations of the method, injection of the aerosol sample into the mass spectrometer is performed in the absence of collection on a membrane.

In some example implementations of the method, injection of the aerosol sample into the mass spectrometer is performed in the absence of Venturi action.

In some example implementations of the method, injection of the aerosol sample into the mass spectrometer is performed in the absence of aerosol manipulation via electromagnetic fields.

In another aspect, there is provided a method of performing analysis of a collected aerosol, the method comprising:
employing an aerosol generating device to generate an aerosol plume from a material;
during and/or after generation of the aerosol plume by the aerosol generating device, collecting, via suction generated by a pump, an aerosol sample into a chamber, such that collection of the aerosol sample is temporally controlled relative to the generation of the aerosol plume, the aerosol sample comprising at least a portion of the aerosol plume;
bringing the chamber into fluidic communication with an inlet of an analysis device; and
injecting the aerosol sample from the chamber to the analysis device.

In another aspect, there is provided a system for performing mass spectrometry on a collected aerosol, the system comprising:
an aerosol generating device operable for generating an aerosol plume;
a mass spectrometer;
a chamber, wherein the chamber is in fluidic communication with a first fluidic conduit and a second fluidic conduit, wherein the first fluidic conduit comprises a first distal port located proximal to a location of generation of the aerosol plume, and wherein the second fluidic conduit comprises a second distal port located proximal to an inlet of the mass spectrometer, and wherein a first valve is provided to control fluid communication between the chamber and the distal port, and wherein a second valve is provided to control fluid communication between the chamber and the second distal port; and
a pump operable to generate suction suitable for collecting an aerosol sample from the aerosol plume into the chamber; and
control and processing circuitry operably connected to the pump, the first valve and the second valve, the control and processing circuitry comprising at least one processor and memory, the memory comprising instructions executable by the processor for performing operations comprising:
   during and/or after generation of the aerosol plume by the aerosol generating device, opening the first valve and employing suction generated by the pump to collect the aerosol sample into the chamber, such that collection of the aerosol sample is temporally controlled relative to generation of the aerosol plume, the aerosol sample comprising at least a portion of the aerosol plume;
   closing the first valve and opening the second valve, thereby bringing the chamber into fluidic communication with the inlet of the mass spectrometer, thereby facilitating injection of the aerosol sample from the chamber to the mass spectrometer.

In some example implementations of the system, the pump is configured to generate suction for collection of the aerosol sample by increasing a volume of the chamber.

The pump may be a syringe pump.

In some example implementations of the system, the mass spectrometer is a slow-scanning mass spectrometer configured to scan a predetermined mass range during an acquisition time exceeding 1 ms.

In some example implementations of the system, the mass spectrometer is a slow-scanning mass spectrometer configured to scan a predetermined mass range during an acquisition time exceeding 1 s.

In some example implementations of the system, the pump is a first pump, the chamber is a first chamber and the aerosol sample is a first aerosol sample, wherein a time duration of generation of the aerosol plume is longer than a time duration of collection of the first aerosol sample by the first pump, and wherein the first aerosol sample comprises a first portion of the aerosol plume, wherein the control and processing circuitry is further configured to control operations comprising:
during and/or after generation of the aerosol plume by the aerosol generating device, actuating a second pump to collect a second aerosol sample into a second chamber, such that control of the second pump and collection of the second aerosol sample occurs after collection of the first aerosol sample by the first pump, the second aerosol sample comprising a second portion of the aerosol plume;
bringing the second chamber into fluidic communication with the inlet of the mass spectrometer; and
injecting the second aerosol sample from the second chamber to the mass spectrometer.

The control and processing circuitry may be further configured such that the second pump is controlled to collect the second aerosol sample while injecting the first aerosol sample from the first chamber to the mass spectrometer.

The control and processing circuitry may be further configured to control the first pump to collect a third aerosol sample from the aerosol plume while injecting the second aerosol sample from the second chamber to the mass spectrometer.

In some example implementations, the system may further include a heater configured to heat the chamber.

In some example implementations, the system may further include a sensor configured to measure a signal dependent on an amount of collected aerosol, the sensor being in fluid communication with the chamber and being operably connected to the control and processing circuitry.

In some example implementations of the system, the control and processing circuitry is further configured to control the pump for collection of the aerosol sample according to feedback from the sensor, such that the aerosol sample is collected until the signal satisfies pre-selected criteria.

The sensor may be configured such that the signal is dependent on humidity. The sensor may be configured such that the signal is dependent on at least one of turbidity, optical absorptivity, optical spectroscopy, and light scattering.

The chamber may be in fluid communication with an inlet of the pump and wherein the control and processing circuitry is further configured to control the first valve and the second valve such that:
prior to collection of the aerosol sample, the first valve and the second valve are closed and the pump is operated to generate a partial vacuum in the chamber; and
collection of the aerosol sample from the aerosol plume is performed while operating the pump with the first valve in an open state and the second valve in a closed state.

In some example implementations of the system, injection of the aerosol sample into the mass spectrometer is facilitated, at least in part, by intrinsic suction of the mass spectrometer with the second valve in an open state.

In some example implementations of the system, the control and processing circuitry is further configured to control the first valve and the second valve such that, after collecting the aerosol sample into the chamber, the first valve and the second valve are closed to prevent fluid communication between the chamber and an external ambient environment for a dwell time interval.

In some example implementations, the system may further include a pressure sensor in fluid communication with the chamber, the pressure sensor being configured to measure a pressure signal dependent on a pressure within the chamber, and wherein the control and processing circuitry is further configured such that:
prior to collection of the aerosol sample, the pressure signal is monitored while generating the partial vacuum; and
after determining that a sufficient partial vacuum has been established, the aerosol generating device is controlled to initiate generation of the aerosol plume and opening the first valve to facilitate collection of the aerosol sample.

In some example implementations, the system may further include a pressure sensor in fluid communication with the chamber, the pressure sensor bring to configured to measure a pressure signal dependent on a pressure within the chamber, and wherein the control and processing circuitry is further configured such that:
the pressure signal is monitored during collection of the aerosol sample; and
after determining that the pressure has reached atmospheric pressure, the first valve is closed to prevent further collection.

In some example implementations of the system, the aerosol sample is injected in the absence of operation of the pump.

In some example implementations of the system, the pump is a bidirectional pump, and wherein the control and processing circuitry is further configured such that the pump is operated in a first direction during collection of the aerosol sample, and wherein the pump is operated in a reversed direction during injection of the aerosol sample.

In some example implementations of the system, the pump is a first pump, and wherein a second pump resides inline with the second fluidic conduit and is operated during injection of the aerosol sample, in the absence of operation of the first pump.

In some example implementations of the system, the second fluidic conduit comprises a T-junction for facilitating the introduction of air with the aerosol sample during injection of the aerosol sample.

In some example implementations, the system may further include a mass flow controller, the mass flow controller having an inlet in communication with a source of inert gas source and an outlet in fluid communication with the chamber; wherein the mass flow controller is controlled by the control and processing circuitry to inject the inert gas into the chamber at a controlled flow rate during injection of the aerosol sample. The pump may be absent of operation during injection of the aerosol sample.

A third valve may reside between the chamber and the pump, wherein the third valve is controlled by the control and processing circuitry to be closed during injection of the aerosol sample. A third valve may reside between the chamber and the mass flow controller, wherein the third valve is controlled by the control and processing circuitry to be closed during collection of the aerosol sample and opened during injection of the aerosol sample.

In some example implementations, the system may further include a heater configured to heat the chamber. The heater may be configured to provide sufficient heat to the chamber to maintain the aerosol sample in a dissolved state within the chamber.

In some example implementations of the system, the aerosol generating device is configured to generate the aerosol according to a modality selected from the group consisting of diathermy, ultrasonic aspiration, focused ultrasound, radiofrequency ablation, nebulization, laser desorption, laser ablation and photoacoustic drilling.

In another aspect, there is provided a system for performing analysis of a collected aerosol, the system comprising:
an aerosol generating device operable for generating an aerosol plume;
an analytic device;
a chamber, wherein the chamber is in fluidic communication with a first fluidic conduit and a second fluidic conduit, wherein the first fluidic conduit comprises a first distal port located proximal to a location of generation of the aerosol plume, and wherein the second fluidic conduit comprises a second distal port located proximal to an inlet of the analytic device, and wherein a first valve is provided to control fluid communication between the chamber and the distal port, and wherein a second valve is provided to control fluid communication between the chamber and the second distal port; and
a pump operable to generate suction suitable for collecting an aerosol sample from the aerosol plume into the chamber; and
control and processing circuitry operably connected to the pump, the first valve and the second valve, the control and processing circuitry comprising at least one processor and memory, the memory comprising instructions executable by the processor for performing operations comprising:
   during and/or after generation of the aerosol plume by the aerosol generating device, opening the first valve and employing suction generated by the pump to collect the aerosol sample into the chamber, such that collection of the aerosol sample is temporally controlled relative to generation of the aerosol plume, the aerosol sample comprising at least a portion of the aerosol plume;
   closing the first valve and opening the second valve, thereby bringing the chamber into fluidic communication with the inlet of the analytic device, thereby facilitating injection of the aerosol sample from the chamber to the analytic device.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1A shows an example embodiment of a system for performing controlled collection of an aerosol sample from an aerosol plume and subsequent injection of the aerosol sample into an analytic device.

FIG. 1B illustrates an example method for performing controlled collection of an aerosol sample from an aerosol plume and subsequent injection of the aerosol sample into an analytic device.

FIG. 1C shows an example embodiment in which a syringe pump is employed for collection of the aerosol sample from an aerosol plume.

FIG. 1D illustrates an example alternate system configuration in which the first and second conduits are separately interfaced with the chamber.

FIG. 1E and FIG. 1F illustrate an example alternate system configuration in which the distal end of a fluid conduit is movable between the aerosol plume and the inlet of the analytic device.

FIG. 1G and FIG. 1H illustrate an example alternate system configuration in which the chamber is transported to interface with a remote analytic device after collection of the aerosol sample.

FIG. 2A illustrates an example alternate system configuration in which a pump is employed to at least partially evacuate the chamber prior to the generation and collection of the aerosol plume.

FIG. 2B illustrates an example method of operating the system illustrated in FIG. 2A.

FIG. 2C is a table presenting example parameters for the system shown in FIG. 2A.

FIG. 2D is a table presenting example flow rates for the pump shown in FIG. 2A.

FIG. 2E illustrates an example method of operating the system illustrated in FIG. 2A using a bi-directional pump.

FIG. 3A illustrates an example alternate system configuration in which a second pump is employed to facilitate injection of the collected aerosol plume to the analytic device.

FIG. 3B illustrates an example method of operating the system illustrated in FIG. 3A.

FIG. 4A illustrates an example alternate system configuration in which a mass flow controller is employed to facilitate injection of the collected aerosol plume to the analytic device.

FIG. 4B illustrates an example method of operating the system illustrated in FIG. 4A.

FIG. 5 illustrates an example implementation in which a T-junction is provided to allow balancing of the difference between the flow capabilities of the pump and the suction capabilities of the analytic device by permitting air to flow through a port of the T-junction.

FIG. 6 plots the threshold fluence, as a function of wavelength, for ionization and for ablation via the PIRL impulsive heat deposition mechanism.

FIG. 7 schematically illustrates an example control system for performing controlled collection of an aerosol sample from an aerosol plume and subsequent injection of the aerosol sample into an analytic device.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Unless defined otherwise, all technical and scientific terms used herein are intended to have the same meaning as commonly understood to one of ordinary skill in the art. Unless otherwise indicated, such as through context, as used herein, the following terms are intended to have the following meanings:
As used herein, the phrase “aerosol generating device” refers to a device that generates an aerosol plume, via actively modulating, disrupting, ablating, aspirating, nebulizing or spraying a specimen, object or material.

As used herein, the phrase “temporally unstable aerosol plume” is an aerosol plume that has a composition that varies (e.g., fluctuates) with time during generation of the aerosol plume. A “spatially heterogenous” or “spatially inhomogeneous” aerosol plume has a composition and/or density that varies (e.g., fluctuates) across its spatial extent.

Some volatile substances, such as volatile liquids, passively generate an aerosol that can be collected as a headspace gas for subsequent analysis. Such aerosols are temporally stable and spatially homogeneous and may be readily sampled into an analytic device, such as a mass spectrometer, using conventional injection methods, such as via the innate suction of a mass spectrometer.

In contrast, however, the use of an aerosol generating device used with a temporally or spatially heterogeneous specimen or object often results in the formation of an aerosol plume with a temporally varying and/or spatially heterogeneous composition. For example, the use of ultrafast pulsed infrared laser desorption to generate, from a biological tissue, an aerosol plume that contains a wide range of biomolecules in the gas phase, will typically exhibit a temporally varying and spatially inhomogeneous aerosol plume composition.

This temporal and/or spatially heterogeneous variation in composition of an aerosol plume, formed by an aerosol device, can occur for a number of reasons. The production rate of an aerosol plume from a sample can be dependent on one or more operational parameters of parameters of the aerosol generation mechanism. For example, the repetition rate of an aerosol generating infrared laser beam (e.g., continuous 0 Hz to 500 MHZ) can result in temporal variations and/or spatial variations. In the case of the generation of an aerosol a biological sample using an aerosol device, the resulting aerosol plume can exhibit temporal variations and spatial inhomogeneities in composition, both as a consequence of a temporally-varying aerosol production rate and the inherently inhomogeneous structure of tissue (e.g., the presence of different cell types at different locations within a biological specimen).

Such temporal variations and/or spatially inhomogeneities in the composition of an aerosol plume can present challenges for sampling and analysis using conventional ambient mass spectrometer devices and methods. For example, a mismatch between an aerosol generation rate and a sample volume intake rate can lead to unstable mass spectra acquired by a mass spectrometer. Indeed, the temporal variations and/or spatial inhomogeneities in the composition during generation of the aerosol plume can cause an aerosol sample collected from the aerosol plume to have a composition that varies during the timescale of sample injection into a mass spectrometer and/or spectral data acquisition, particularly in the case of some slow-response (i.e. slow-scanning) mass spectrometry technologies, often implemented as compact mass spectrometers, that often require a longer data acquisition time duration for mass analysis than a conventional mass spectrometer.

While time-of-flight (TOF) type spectrometers can sometimes be employed to detect the aerosol sample over timescales that are faster than those associated with temporal variations that occur during the generation of an aerosol plume, such spectrometers are unfortunately large and expensive, and are often not suitable for deployment in smaller spaces.

Instead, it is more common for inexpensive slow-response scanning mass spectrometers to be employed for many applications. Such slow-response mass spectrometers typically employ scanning technologies to compute a mass spectrum by sequentially performing a set of scans across many smaller mass-to-charge range windows. Slow-response scanning spectrometers typically possess lower resolving power than time-of-flight systems but require a stable aerosol signal over the entire scanning range (i.e., over the full scan time) to be able to record reliable mass spectra from introduced aerosols. Moreover, slow-response mass spectrometry systems often have a low intrinsic intake rate and do not possess large inner volumes to support sufficient evacuation and suction. Accordingly, when such mass spectrometers are employed to detect mass spectra from aerosol plumes having temporal and/or spatial variations, this requirement for signal stability over long timescales often results in the collection of unstable mass spectra or mass spectra with poor signal-to-noise ratios.

Furthermore, with signal averaging at the data acquisition stage being common in mass spectrometry, it can be important for the sampled aerosol to be temporally stable not just over a single scan, but over multiple scans that are employed for averaging. Mass spectrometers which acquire the full range of masses in a single acquisition event are able to average temporal fluctuations in the signal amplitude across all masses at once, over multiple acquisition events. This does not affect the shape of the spectrum, only the observed ion abundance values. In contrast, mass spectrometers which acquire signal through repeated sampling of smaller mass units to construct the full range mass spectrum in series will be sensitive to temporal fluctuations in observed ion abundance values that will convolve and hence distort the spectral shape measured by the sequence of the sampling events. This creates the necessity for a temporally stable aerosol composition over multiple mass scans can exacerbate the aforementioned problems associated with the use of slow-response scanning mass spectrometers for the detection of aerosol samples collected from a temporally varying and/or spatially inhomogeneous aerosol plume.

These challenges have thus favored use of rapid response time-of-flight type spectrometers to examine temporally unstable, temporally heterogenous (generated) or inherently unstable aerosol signals, hindering the adoption and use of slow-response scanning mass-spectrometers.

The present inventors sought to overcome the aforementioned problems associated with the use of ambient (and non-ambient) mass spectrometry for the analysis of aerosol plumes that exhibit temporal variation and/or spatial inhomogeneity. Many of the example embodiments disclosed herein overcome the problems associated with conventional aerosol collection and injection methods by decoupling the aerosol sample collection process from the aerosol sample injection process via the use of an intermediate collection chamber, into which an aerosol sample is collected from an aerosol plume prior to injection into an analytic device such as a mass spectrometer. In particular, several of the example embodiments disclosed herein employ temporal coordination between the generation of the aerosol plume and the collection of an aerosol sample from the aerosol plume into an intermediate chamber, followed by the controlled injection of the aerosol sample into an analytic device. These example embodiments have been found to facilitate a reduction in the temporal variations (stability) and/or the spatial inhomogeneity of the composition of the aerosol sample that is injected into the analytic device, thereby potentially enabling the use of slow-response scanning (non-TOF) mass spectrometers to detect mass spectra from aerosol plumes.

Many embodiments of the present disclosure allow for reduction of the temporal instability and heterogeneity of aerosol samples collected from an aerosol plume before injecting the aerosol sample into an analytic device that would be otherwise adversely influenced by the presence of temporal signal heterogeneity (or stability). As such, the present example embodiments facilitate the improved use of an analytic device that requires signal processing and/or averaging on timescales that are comparable to the temporal heterogeneity of an aerosol plume. Furthermore, example embodiments of the present disclosure further serve to facilitate averaging of cell type heterogeneity without the need for post-acquisition signal processing and or mathematical deconvolution of spatially heterogenous signals post-data collection.

In particular, in some example embodiments, the volumetric rate of collection of the aerosol sample is selected to generate a sufficient amount of turbulence during collection to reduce and/or suppress temporal variation and/or spatial heterogeneity of the composition of the aerosol sample, thereby facilitating improved homogeneity of the aerosol sample that is subsequently injected into the analytic device.

Moreover, in some example embodiments, the volumetric rate of injection of the aerosol sample into the analytic device, which is independent of the volumetric rate of collection of the aerosol sample, is selected such that the aerosol sample is delivered to the analytic device over a time duration that is adapted according to the properties of the analytic device, such as over a time duration suitable for achieving a stable signal during data acquisition by the analytic device. For example, the volumetric rate of injection of the aerosol sample into the analytic device may selected such that a time duration of injection is less than a time duration of data acquisition by the analytic device (for example, a time duration required by a mass spectrometer for performing one mass analysis scan, or, for example, for performing a series of mass analysis scans for averaging).

As explained in further detail below, the decoupling of the collection of the aerosol sample from the aerosol plume and the injection of aerosol sample into the analytic device can be beneficial avoiding the need to use of a venturi-type augmentation and/or a pusher gas during injection of the aerosol sample, thereby avoiding diluting the aerosol sample during collection of the aerosol sample.

Accordingly, in some example embodiments of the present disclosure, systems and methods are provided that facilitate the use of slow-response scanning mass spectrometers to detect aerosol signals from aerosol plumes despite the presence of temporal instabilities during generation of the aerosol plume, thereby facilitating the acquisition of mass spectra with an improved signal-to-noise ratios.

In particular, many example embodiments of the present disclosure do not require or rely on the use of electromagnetic or radiofrequency modulation of aerosols, as is conventionally performed in ion trap instruments. In contrast, the example embodiments of the present disclosure employ suction, generated by a pump (pump mechanism) to collect an aerosol sample from an aerosol plume into a chamber, prior to subsequently injecting the collected aerosol sample into the mass spectrometer, thereby homogenizing the aerosol sample and reducing temporal variations and spatial inhomogeneities in the aerosol sample prior to injection.

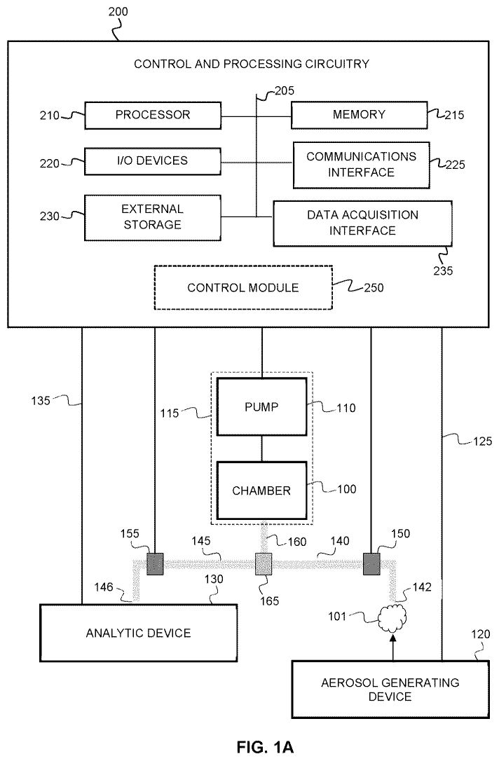

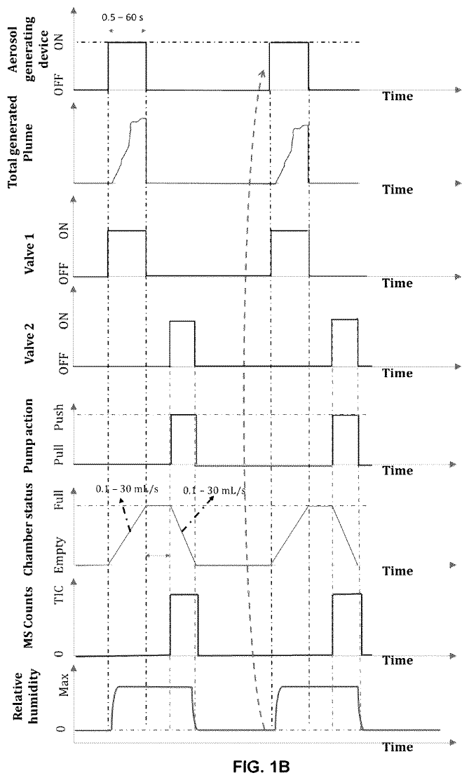

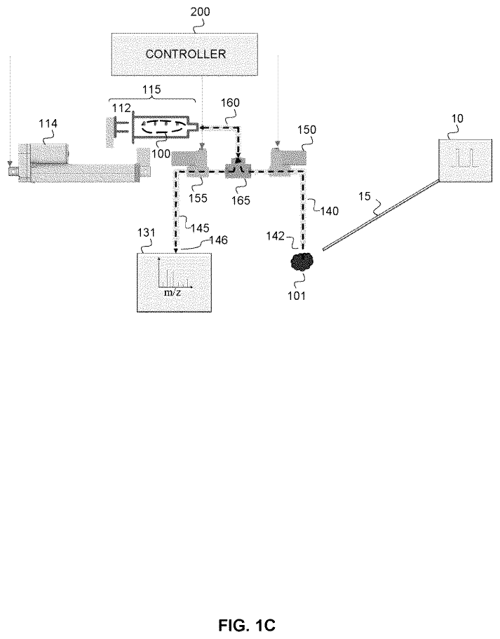

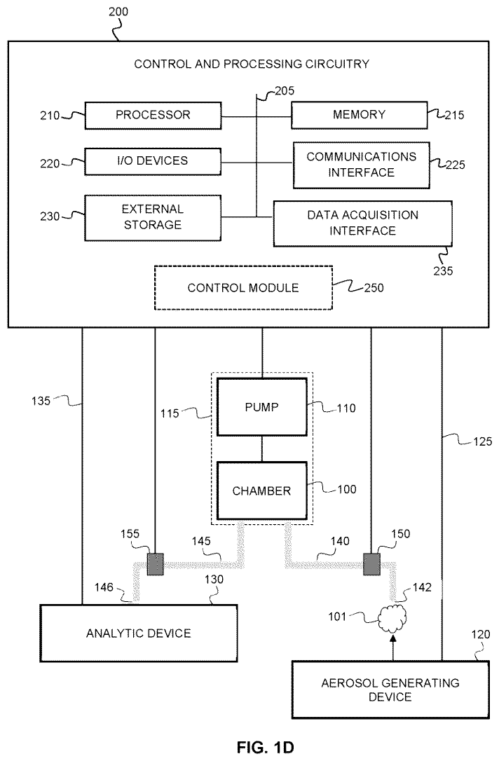

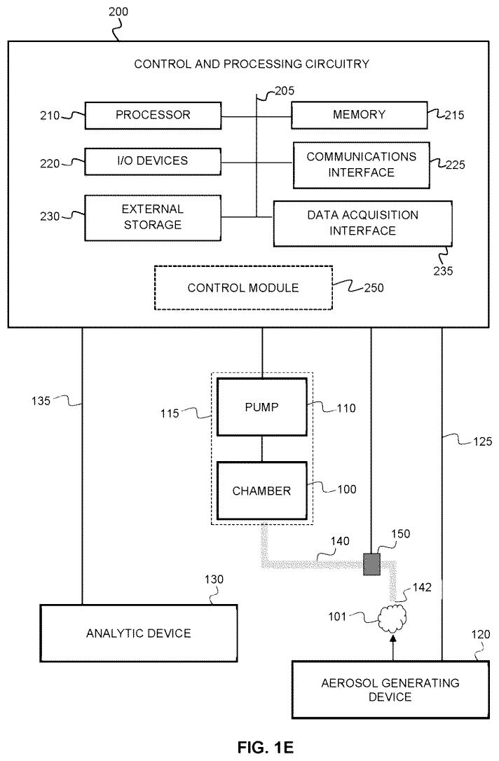

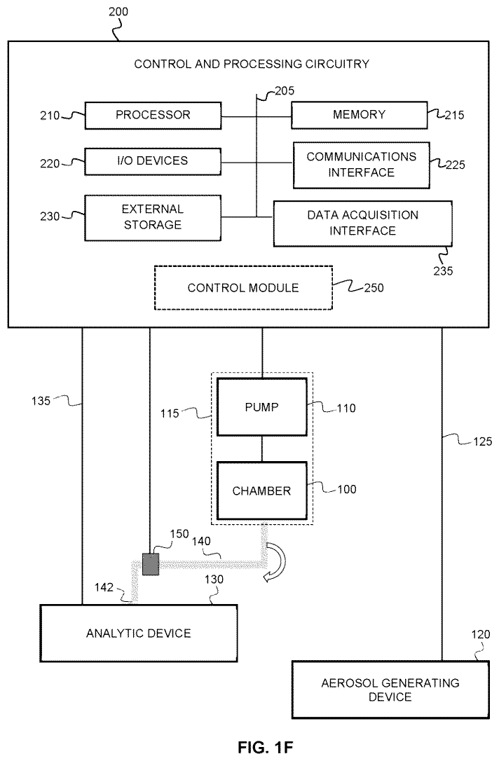

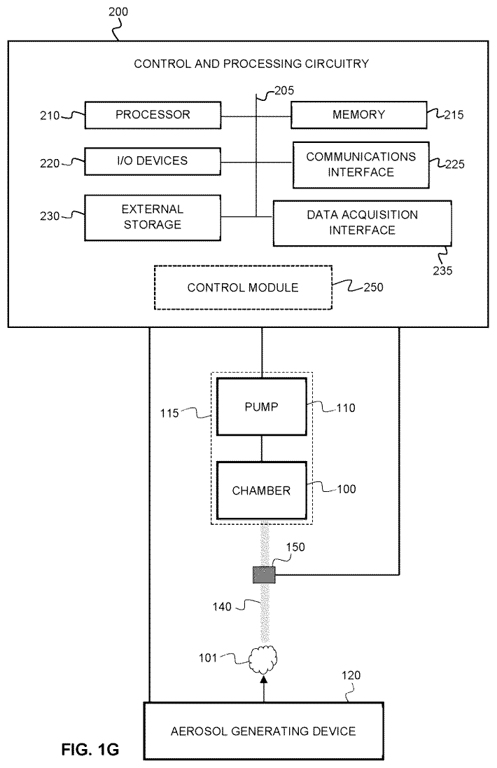

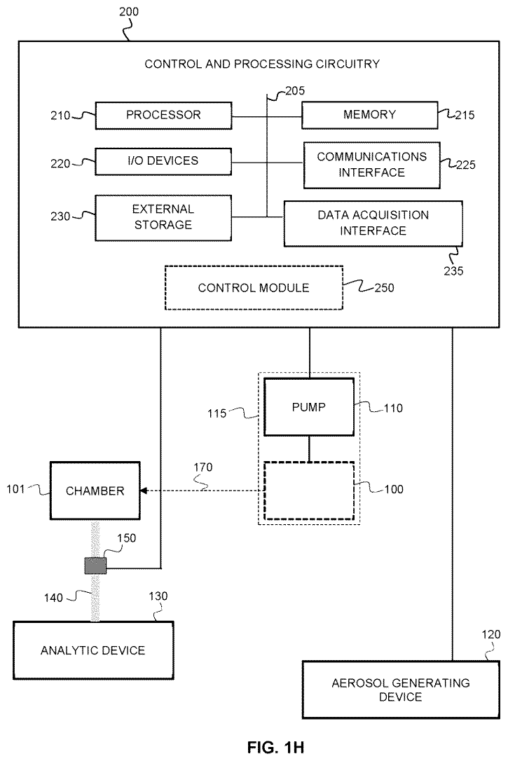

Referring now to FIG. 1A, an example embodiment is illustrated in which an aerosol device 120 is employed to generate an aerosol plume 101. Examples of suitable aerosol devices are described in detail below. The system includes a chamber 100 and a pump 101, where the pump in fluid connection with the chamber 100, or is integrated with the chamber 100 as shown at 115, to generate suction within the chamber to facilitate collection, into the chamber 100, of an aerosol sample from the aerosol plume 101. Operation of the pump 110 is controlled by control and processing circuitry 200. As shown in the figure at 125, the aerosol device 120 may also be controlled by the control and processing circuitry 200.

FIG. 1A illustrates an example implementation in which the chamber 100 is in fluidic communication with a first fluidic conduit 140 and a second fluidic conduit 145. The first fluidic conduit 140 has a first distal port 142 located proximal to a location of generation of the aerosol plume 101, while the second fluidic conduit 145 has a second distal port 146 located proximal to the inlet of an analysis device 130 (such as a mass spectrometer).

A first valve 150 is provided to control fluid communication between the chamber 100 and the first distal port 142, while a second valve 155 is provided to control fluid communication between the chamber 100 and the second distal port 146, with both valves being controlled by the control and processing circuitry 200. The figure shows an example implementation in which proximal ends of the first fluidic conduit 140 and the second fluidic conduit 145 are brought into fluidic communication with the chamber 100 through a T-junction 165 and a third fluidic conduit 160.

The present example system facilitates the independent control of the collection rate of the aerosol sample from the aerosol plume 101 and the injection rate of the aerosol sample into the analysis device 130. This decoupling of the collection and subsequent injection of the aerosol sample is illustrated in the method shown in FIG. 1B, with reference to FIG. 1A. During or after the generation of the aerosol plume 101 by the aerosol device 120, the first valve 150 is opened, the second valve 155 is closed, and suction generated by the pump is employed to generate, within the chamber 100, a reduction in pressure relative to the ambient pressure at the location of the generation of the aerosol plume. This reduction in pressure generates suction that draws the aerosol sample from the aerosol plume 101 into the chamber 100, such that at least a portion of the aerosol sample resides in the chamber 100.

As shown in FIG. 1B, the pump may be a bi-directional pump, such as a syringe pump (described in further detail below), that is capable of generating suction to draw the aerosol sample into the chamber during the collection phase. The figure shows the pump as being operated in “pull” (i.e. suction) mode in the collection stage, even when valve 150 is closed, which can facilitate the generation of a negative pressure within the chamber relative to ambient. However, as described below, in some embodiments, the pump need only be operated in “pull” mode when the first valve 150 is opened.

After having collected the aerosol sample into the chamber 100, and after an optionally time duration during which the aerosol sample is retained within the chamber 100 (optionally with the first valve 150 in a closed state, as illustrated in FIG. 1B, and optionally with the pump in a non-operational state, i.e. neither generating suction nor pressure), the first valve 150 is closed, the second valve 155 is opened, and the aerosol sample is injected into the through the second fluidic conduit 145 to the inlet of the analysis device 130.

FIG. 1B also shows the change in humidity level during the collection, optional retention, and injection phase. As described below, humidity, or other measures associated with the presence or absence of the aerosol sample (such as, for example, pressure, or optical measures associated with light scattering) may be employed as feedback measures to control the timing of the collection and/or injection phases.

While FIG. 1B illustrates an example method in which the injection of the aerosol sample is actively controlled, via control of the pump by the control and processing circuitry 200, in alternative example implementations, the injection of the collected aerosol sample from the chamber 100 can be performed passively, based on inherent suction of the analysis device. Examples of such alternative implementations are described and illustrated below.

As shown in FIG. 1B and described above, the collection of the aerosol sample into the chamber 100 is temporally controlled relative to initiation of the generation of the aerosol plume 101 by the aerosol generating device. This temporal control may be implemented, for example, in the form of synchronization of the initiation of collection of the aerosol sample with the onset of the generation of the aerosol plume, as shown, for example, in FIG. 1B. Alternatively, the collection of the aerosol sample can be initiated at a prescribed delay prior to the onset of the generation of the aerosol plume, or at a prescribed delay after the onset of the generation of the aerosol plume.

It will be understood that the timing of the collection of the aerosol plume can be controlled, relative to the generation of the aerosol plume, according to many different example implementations. For example, a trigger signal can be provided from the aerosol device 120 to the control and processing circuitry 200, thereby enabling the control and processing circuitry 200 to initiate the collection of the aerosol sample upon initiation of the generation of the aerosol plume, or at a prescribed delay relative to the initiation of the generation of the aerosol plume. Alternatively, the aerosol device 120 can be controlled by the control and processing circuitry 200, such that the control and processing circuitry 200 controls the timing of both the initiation of the generation of the aerosol plume and the collection of the aerosol sample from the aerosol plume. In another alternative example implementation, a detection device (e.g., a camera, photodiode, pressure sensor or acoustic sensor) can be employed to detect the initiation of the generation of the aerosol plume, and a signal from the detection device can be employed by the control and processing circuitry 200 to control the collection of the aerosol sample from the aerosol plume (such an approach does not require interfacing of the aerosol device 120 with the control and processing circuitry 200).

Referring again to FIG. 1A, the example control and processing circuitry 200 may include a processor 210, a memory 215, a system bus 205, one or more input/output devices 220, and a plurality of optional additional devices such as communications interface 225, external storage 230, and a data acquisition interface 235. In one example implementation, a display (not shown) may be employed to provide a user interface for facilitating input to control the operation of the system 200. The display may be directly integrated into a control and processing device (for example, as an embedded display), or may be provided as an external device (for example, an external monitor).

The control and processing system 200 may include or be connectable to a console 280 that provides an interface for facilitating an operator to control the aerosol device 120. The console may include, for example, one or more input devices, such, but not limited to, a keypad, mouse, joystick, touchscreen, and may optionally include a display device.

The methods described herein, such as methods for controlling the collection and subsequent injection of an aerosol sample from an aerosol plume, or other example methods described herein, can be implemented via processor 210 and/or memory 215. As shown in FIG. 1A, executable instructions represented as control module 250 are processed by control and processing circuitry 200. Such executable instructions may be stored, for example, in the memory 215 and/or other internal storage.

The methods described herein can be partially implemented via hardware logic in processor 210 and partially using the instructions stored in memory 215. Some embodiments may be implemented using processor 210 without additional instructions stored in memory 215. Some embodiments are implemented using the instructions stored in memory 215 for execution by one or more microprocessors. Thus, the disclosure is not limited to a specific configuration of hardware and/or software.

It is to be understood that the example system shown in the figure is not intended to be limited to the components that may be employed in a given implementation. For example, the system may include one or more additional processors. Furthermore, one or more components of control and processing circuitry 200 may be provided as an external component that is interfaced to a processing device. Furthermore, although the bus 205 is depicted as a single connection between all of the components, it will be appreciated that the bus 205 may represent one or more circuits, devices or communication channels which link two or more of the components. For example, the bus 205 may include a motherboard. The control and processing circuitry 200 may include many more or less components than those shown.

Some aspects of the present disclosure can be embodied, at least in part, in software, which, when executed on a computing system, transforms an otherwise generic computing system into a specialty-purpose computing system that is capable of performing the methods disclosed herein, or variations thereof. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version. Alternatively, the logic to perform the processes as discussed above could be implemented in additional computer and/or machine-readable media, such as discrete hardware components as large-scale integrated circuits (LSI's), application-specific integrated circuits (ASIC's), or firmware such as electrically erasable programmable read-only memory (EEPROM's) and field-programmable gate arrays (FPGAs).

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

Referring again to FIG. 1A, it will be understood that the pump (or a pump mechanism) may be incorporated according to a wide variety of implementations. For example, the pump 110 may be employed to actively generate suction during the collection of the aerosol sample. Alternatively, the pump may be employed to generate a partial vacuum within the chamber 100 prior to opening the first valve 150, such that the aerosol sample can be collected passively by opening the first valve 150, with the partial vacuum generating the suction for collecting the aerosol sample, optionally without operating the pump.

In some example implementations, the pump is configured to control the volume of the chamber 100 in order to generate pressure differences within the chamber 100. For example, if the first valve 150 is opened, the second valve 155 is closed, and the volume of the chamber 100 is increased, the resulting suction will draw the aerosol sample from the aerosol plume into the chamber 100. Likewise, after closing the first valve 150, opening the second valve 155, and reducing the volume of the chamber 100, the resulting pressure increase will result in the injection of the collected aerosol sample to the analysis device 130.

Referring now to FIG. 1C, an example embodiment is illustrated in which a laser source 10 (an example of an aerosol generating device or mechanism) is employed to deliver laser pulses (e.g., through an optical waveguide 15) to a sample. Ablation of the sample by the laser pulses leads to the generation of the aerosol plume 101.

In the present example embodiment, the pump 115 is a syringe pump that includes a piston 112 and the chamber 100. The piston 112 is translated within the chamber 100 by a syringe pump drive mechanism 114. Operation of the syringe pump drive mechanism 114 is controlled by the controller 200. As shown in the figure, the chamber 100 of the syringe pump 115 is in fluidic communication with the first fluidic conduit 140 and the second fluidic conduit 145.

During or after the generation of the aerosol plume 101 by the laser source 10, the first valve 150 is opened, the second valve 155 is closed, and the piston 112 is retracted into the chamber 100 to generate a reduction in pressure relative to the ambient pressure at the location of the generation of the aerosol plume 101. This reduction in pressure generates suction that draws an aerosol sample from the aerosol plume 101 into the chamber 100, such that at least a portion of the aerosol sample resides in the chamber 100. After having collected the aerosol sample into the chamber 100, and after an optionally time duration during which the aerosol sample is retained within the chamber 100 (optionally with the first valve 150 in a closed state), the first valve 150 is closed, the second valve 155 is opened, and the piston 112 is driven forward within the chamber 100 to deliver the aerosol sample through the second fluidic conduit 145 to the inlet of the mass spectrometer 131.

It will be understood that FIG. 1A shows one non-limiting example implementation of how the chamber 100 may be brought into fluid communication with the aerosol plume 101 and the analysis device 130. An alternative example implementation is shown in FIG. 1D in which the first and second fluidic channels 140 and 145 are separately interfaced with the chamber 100.

Another example implementation that only employs a single valve and single conduit is shown in FIGS. 1E and 1F. As shown in FIG. 1E, during collection of the aerosol sample from the aerosol plume 101, the fluidic conduit 140 is positioned such that its distal port 142 is proximal to the location of the generation of the aerosol plume 101. However, as shown in FIG. 1F, after the aerosol sample is collected into the chamber 100, the fluidic conduit 140 is moved (e.g., pivoted, via a rotatable fluidic joint or a flexible portion of the fluidic conduit 140) such that the distal port 142 is proximal to the inlet of the analysis device 130.

In some example embodiments, the after collection of the aerosol sample into the chamber, the chamber 100 is closed or sealed and transported to a remote location, where it is subsequently interfaced with the analytic device for the injection of the aerosol sample. The chamber may be transported during a prescribed dwell time of the aerosol sample within the chamber 100. For example, FIGS. 1H and 1G illustrate an example implementation in which the chamber is transported, after the closing of the valve 150, to a location where the distal end 142 of the conduit 140 is brought into fluid communication with the inlet of the mass analysis device 130. The valve 150 may then be opened such that the collected aerosol sample is drawn into the analysis device 130 by the inherent suction of the analysis device 130. Alternatively, for example, the pump 110 may be transported with the chamber 100 (e.g., in the case of a syringe pump) and the pump 110 may be actuated to inject the collected aerosol sample into the analysis device 130. The pump may be decoupled from the control and processing circuitry 200 during transport, and subsequently actuated manually, or using a second control and processing system, to inject the aerosol sample to the analysis device 130. In some example implementations, the analysis device 130 may be located remote from the aerosol device 120, such as in a different room.

The present example embodiments facilitate decoupling between collection (intake) and injection, thereby solving the aforementioned problem of a mismatch between the rapid timescale of temporal fluctuations in an aerosol plume and the slower data acquisition timescales of many compact mass spectrometers, which require long sampling times and, as a consequence of their small inner volumes, typically exhibit a low intrinsic intake rate compared to larger spectrometers with larger internal volumes and sampling times. By decoupling collection (intake) and injection, the present example embodiments enable the collection and injection rates to be separately configured for sampling from the aerosol plume and injection into the analysis device.

As discussed above, the example embodiments of the present disclosure also enable control of the injection time duration of the aerosol sample (i.e., via control of the injection flow rate) such that stable signal is introduced to the analysis device at time durations and/or flow rates that are adapted to the requirements of the analysis device. In some example implementations, the aerosol sample, which is homogenized during collection into the chamber, is subsequently injected during a time duration that facilitates optimal performance (i.e., acquisition of signal) of the analysis device (e.g., mass analyzer).

Various embodiments of the present disclosure also facilitate an improvement in the duty cycle of scanning mass spectrometers (such as but not limited to single quadrupole or ion trap spectrometers) or compact mass spectrometer systems that do not offer sufficient suction for long transport (>1 m) of analytes (<2 L/min of suction and typically less than 0.5 L/min of suction). While such devices are not suitable for the sampling and detection of aerosol plumes having significant temporal variations or temporal instability (e.g., aerosol plumes generated from pulsed ablation sources), especially if the plume is generated at long (>1 m) distance from the spectrometer, these problems are avoided by the present example embodiments in which the aerosol sample is injected with an injection time duration and/or flow rate that is different from that of collection.

The present example embodiments are also beneficial in reducing the temporal variations and/or spatial heterogeneity of an aerosol sample that is sampled from an aerosol plume. This reduction is in temporal variations and/or spatial heterogeneity is achieved by collecting the aerosol sample in an intermediate chamber, thereby mixing the aerosol sample prior to subsequent injection of the aerosol sample into the analytical device. In some example implementations, a volumetric rate of collection of the aerosol sample from the aerosol plume may be selected such that a rate of depletion of the aerosol plume by the collection of the aerosol sample is approximately equal to a rate of generation of the aerosol plume.

In some example implementations, the collection time and/or collection flow rate of the collected aerosol sample, and the injection time and/or injection flow rate of the collected aerosol sample, may be defined by a user or operator, such that the collected aerosol sample is stabilized, and such that the injected aerosol sample is stable, spatially and temporally homogenous over the time duration of signal acquisition (e.g., over a plurality of mass scans of a mass spectrometer that are employed for averaging).

The operator can determine suitable collection and injection times according to several example methods. A suitable collection time (and optional incubation time) may be determined, for example, based on a known time duration of the generation of the aerosol plume. In some example implementations, the collection time may be selected to be less than the time duration for the generation of the aerosol plume. In other example implementations, the collection time may be selected to be equal to, or, for example, greater than the time duration for the generation of the aerosol plume. Alternatively, a suitable collection time (and optional incubation time) may be determined, for example, by determining a sufficient time duration to achieve a sufficient level of signal stability (or signal-to-noise ratio) of the detected signal from the analysis device. Signal homogenization can be inferred, for example, in the case of mass spectrometry, by examining mass spectral contents at t=min and t=max times of injection time to the mass spectrometer). A suitable injection time, and/or injection flow rate, can be determined based on the known flow rate and/or scanning time of the analysis device.

In some example implementations, the collection and the injection of the aerosol sample is timed such that during injection of the aerosol sample into the mass spectrometer, a composition of the injected aerosol sample is substantially constant. In some example implementations the collection and the injection of the aerosol sample is configured such that during injection of the aerosol sample into the mass spectrometer, a composition of the aerosol sample is substantially homogeneous. In some example implementations, a time duration of collection of the aerosol sample from the aerosol plume is longer than a time duration of injection of the aerosol sample into the mass spectrometer. In some example implementations, a time duration of collection of the aerosol sample from the aerosol plume is shorter than a time duration of injection of the aerosol sample into the mass spectrometer. The mass spectrometer may be configured to scan a mass range at a prescribed a duty cycle, and the injection of the aerosol sample may be configured to occur during an active portion of the duty cycle.

In some example implementations, the volumetric flow rate collection of the aerosol sample is between 0.1-30 ml/s. The time duration of collection of the aerosol sample may be slower than the time duration of generation of the aerosol plume. In some example implementations, the time duration of collection of the aerosol sample into the chamber lies between 5-30 seconds. In some example implementations, the time duration of collection of the aerosol sample into the chamber is less than 60 seconds.

The time duration of injection of the aerosol plume into a mass spectrometer may be shorter or longer than the time duration of the data acquisition of the mass spectrometer, the latter of which can be in the range of millisecond to seconds (1 millisecond to 60 seconds per sampling event, where each experiment may utilize at least one sampling event).

As described above, the collected aerosol sample may be retained within the chamber for a dwell time prior to injection into the analytical device. Example dwell times of the collected aerosol sample within the chamber range between 0 to 600 seconds. While conventional methods of aerosol analysis in environmental and clinical research rely on passive trapping of aerosols on a solid phase, such as membranes or filters, which are later either analyzed directly from the membrane or after extraction therefrom, the present example embodiments facilitate the persistence (for example, over a duration of up to 10 minutes, or in excess of 10 minutes) of an aerosol sample within the chamber for direct online (direct subsequent injection) or offline analysis (via transport and injection of aerosol sample from the chamber to a remote analysis device) without the need for membrane trapping and subsequent extraction.

In some example implementations, a sensor may be employed that is in fluid communication with an internal volume of the chamber, where the sensor is operably coupled to the control and processing circuitry 200. The control and processing circuitry 200 can employ the signal from the sensor to provide feedback for the control of one or more operations during the collection, and/or incubation, and/or injection of the aerosol sample. For example, the rate of intake of the aerosol sample can be controlled (e.g., by varying the flow rate or pump speed) according to the signal generated by the sensor. In another example implementation, the signal from the sensor can be employed to determine when a sufficient amount of aerosol sample has been collected (e.g., via comparing the sensor signal to a pre-determined threshold), and the pump and/or the first valve can be controlled to turn off once a sufficient amount of aerosol has been collected. In another example implementation, the signal from the sensor can be employed to determine when a sufficient amount of aerosol sample has been injected (e.g., via comparing the sensor signal to a pre-determined threshold), and the pump and/or the second valve can be controlled to turn off once a sufficient amount of the aerosol sample has been injected into the analysis device from the chamber. Non-limiting examples of sensors include an optical sensor that measures turbidity, absorptivity, optical spectra, and/or light scatter, a humidity sensor and a pressure sensor.

It will be understood that a wide variety of aerosol generation mechanisms and/or devices may be employed to generate the aerosol plume, such as laser desorption, mechanical modulation, acoustic modulation, photomechanical modulation, thermal modulation, and electrospray ionization. Non-limiting examples of aerosol generating methods and mechanisms include diathermy (electrocautery), ultrasonic aspiration, focused ultrasound, radiofrequency ablation, nebulization, laser desorption, laser ablation and photoacoustic drilling is compatible with embodiments of the present disclosure. These methods differ from one another, for example, according to: (i) a degree of damage caused to the substrate (e.g., tissue), (ii) an amount of substrate required to produce a certain amount of plume, (iii) chemical and biophysical properties of the generated aerosol plume (e.g., aerosol particle size, ionization state, degree of chemical damage to extracted molecules), and (iv) the amount of aerosolized material produced.

The aerosol plume may be generated from a wide variety of materials. In some example implementations, suitable substrates for the generation of the ablation plume include volatile or non-volatile, non-gaseous materials such as but not limited to liquids and solids, including for example, biological tissues under atmospheric pressure. In some example implementations, the substrate, upon which the aerosol device is applied to generate an aerosol plume, may be provided in a controlled non-ambient (non-atmospheric) environment (such as in a chamber purged with a selected inert gas). In some example implementations, the aerosol plume is generated from a biological specimen, such as a biological tissue and/or a biological liquid, in vitro or in vivo. The aerosolized biomolecules residing in the aerosol plume can be detected as markers for pathological analysis.

The present example embodiments may be implemented for collection of an aerosol sample and injection of the aerosol sample to a wide variety of analytic devices. Non-limiting examples of analytic devices include mass spectrometers, optical spectroscopy systems (e.g. systems configured to perform Raman spectroscopy, vibrational spectroscopy, absorption spectroscopy and/or fluorescence spectroscopy), fluorescence lifetime analysis systems, and gas chromatography systems.

Examples of mass spectrometers for use with the present example embodiments include, but are not limited to, time-of-flight mass spectrometers, ion trap mass spectrometers, and single or triple quadrupole mass spectrometers.

As described above, in some example implementations, the analysis device is a slow-response mass spectrometer. More specifically, a slow-response scanning mass spectrometer, such as a quadrupole mass spectrometer, which may be provided in a compact footprint, is defined herein as a mass spectrometer that scans over a defined mass range during an acquisition time that exceeds one millisecond, and in many cases, can span a duration extending to seconds or even tens of seconds. Non-limiting examples of slow-response mass-spectrometers include single-to-triple quad (quadrupole) mass spectrometers and ion trap mass spectrometers. In implementations in which a single acquisition is performed using a slow-response mass spectrometer, the rate of ion injection needs to be stable over the entire millisecond to second scan duration. In contrast to the aforementioned slow-response mass spectrometers, rapid-scanning mass spectrometers, such as a TOF-MS, are capable of analyzing a mass range via flight times over tens of microsecond (μs) ranges, accelerated or gated within an window of a few ns at the beginning of the ion-flights. For a single acquisition of mass spectrum, the ion injection rate needs to be stable for a few ns per acquisition in case of a TOF-MS. However, as it is common to acquire data over multiple acquisitions, ranging over milliseconds to seconds, which are then averaged to construct the final spectrum, it can also be important for the ion injection rate to be stable over the entire spectrum-construction duration in order to achieve a sufficient good signal to noise ratio.

In some example embodiments, the aerosol plume may be sampled on a continuous repeat cycle mode, in which the aerosol sample is collected from the aerosol plume to the chamber via suction, and with the duration of collection determined according to feedback from a sensor that measures a relevant proxy feature for the presence of the aerosol sample (such as increase in the humidity of the chamber). The feedback signal may be employed to define a suitable intake rate (for example, to maximize aerosol collection). The aerosol sample is then injected into the mass spectrometer and the cycle is repeated using feedback from the collection sensor. The feedback loop may employ a signal from an inline humidity sensor, such that when the signal from the sensor reaches a predefined threshold (determined, for example, based on maximal humidity level from optimized intake rate), the mass spectrometer will be triggered to commence acquisition using a contact closure probe.

In some example embodiments, a second chamber and second pump may be employed to maintain sampling of the aerosol plume during the injection of the initial aerosol sample. Such an embodiment may be beneficial when a time duration of generation of the aerosol plume is longer than a time duration of collection of the aerosol sample, such that the first aerosol sample represents a first portion of the aerosol plume. During and/or after generation of the aerosol plume by the aerosol generating device, a second pump may be employed to collect a second aerosol sample into a second chamber, such that control of the second pump and collection of the second aerosol sample occurs after collection of the first aerosol sample by the first pump. The second aerosol sample therefore provides a second portion of the aerosol plume. The second chamber may then be brought into fluidic communication with the inlet of the mass spectrometer, thereby facilitating injection of the second aerosol sample from the second chamber to the mass spectrometer. The second pump may be controlled to collect the second aerosol sample while injecting the first aerosol sample from the first chamber to the mass spectrometer, and the first pump may be controlled to collect a third aerosol sample from the aerosol plume while injecting the second aerosol sample from the second chamber to the mass spectrometer.

The present example embodiments that employ suction generated by a pump to collect, and optionally retain, an aerosol sample from an aerosol plume, prior to subsequently injecting the aerosol sample to an analytic device, solve many of the problems previously associated with ambient mass spectrometry. Indeed, the present methods may provide a sufficient reduction of temporal variations and spatial heterogeneity such that the resulting signals can be processed, post-sampling, in the absence of mathematical deconvolution. Moreover, the present example embodiments may be employed in the absence of the manipulation of said aerosols using electromagnetic or radiofrequency fields, and/or in the absence of the use of venturi action, and/or in the absence of the use of a pusher or motive gas, thereby avoiding substantial dilution of the aerosol.

While some of the preceding example embodiments employed a pump that had an integrated chamber that changes volume under actuation of the pump, such as a syringe pump, it will be understood that such embodiments are intended to be non-limiting and that other example embodiments may involve a chamber having a fixed volume, where the chamber is interfaced with a pump to generate suction within the chamber for collecting the aerosol sample.

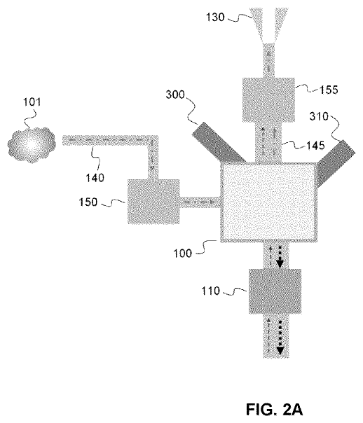

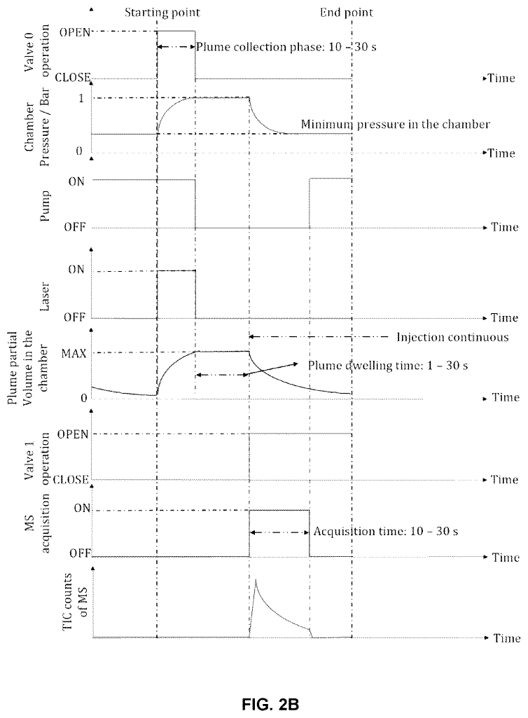

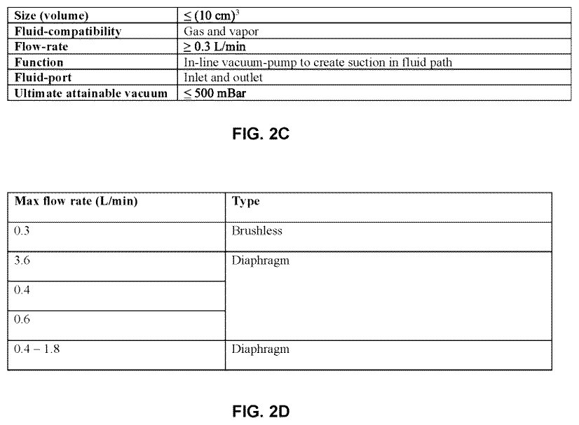

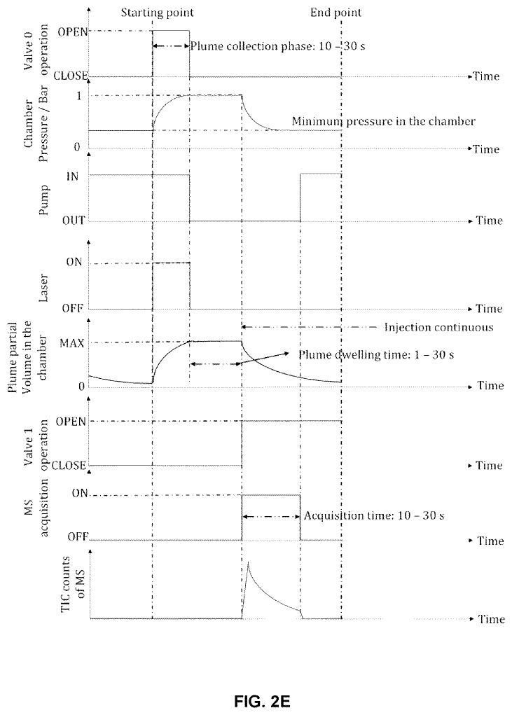

An example of such an embodiment is illustrated in FIG. 2A, in which a pump 110 is employed to at least partially evacuate the chamber 100 prior to the generation of the aerosol plume 101 by the aerosol device, while the first valve 150 and the second valve 155 are closed. During or after the generation of the aerosol plume 101, the first valve 150 is opened and the suction generated by the partial vacuum in the chamber 100 results in the collection of the aerosol sample into the chamber 100 (the pump 110 may be on or off during this collection process). After collecting the aerosol sample and optionally retaining the aerosol sample within the chamber 100 for a dwell time, the second valve 155 is opened and the aerosol sample is injected into the analysis device via the inherent suction of the analysis device, with the pump 110 turned off. FIG. 2B illustrates an example sequence of operations involving the control of the system shown in FIG. 2A for the generation of the aerosol plume, collection of the aerosol sample from the aerosol plume, incubation of the aerosol sample, and injection of an aerosol sample into the analysis device.

As shown in the figure, a heater 300, optionally controllable by the control and processing circuitry (not shown), may be employed to heat the chamber.

FIG. 2A also shows the optional inclusion of a sensor 310 that is in fluid communication with the internal volume of the chamber 100. Examples of different types of sensors are described above.

In one example implementation, the inner volume of the chamber 100 was 120 mL. A ceramic insertion heater 300, controlled with temperature controller to be set between 30° C. and 500° C.) may be attached to the body of the chamber 100 to keep the collected aerosol sample heated at a desired temperature for desolvation of the plume. Before beginning collection of the aerosol sample, both valves 150 and 155 are closed and the pump is operated to create flow in a direction outward from the chamber 100, thus creating a partial vacuum in the chamber 100. To initiate the collection of the aerosol sample from the aerosol plume, the first valve 150 is opened simultaneously with turning on a laser for plume creation via ablation. The initial vacuum in the chamber 100 and the suction of the pump allow the aerosol sample to flow into the chamber 100 and the collection is performed over a time interval between 10 s and 30 s. A fraction of the aerosol sample escapes through the pump, however, the volume fraction of aerosol sample in the chamber 100 will increase with time during collection. After completion of collection, the first valve 150 is closed and the pump 110 is turned off. The aerosol sample is held within in the heated chamber 100 for the defined dwell-time (e.g., a time duration between 0 s and d 30 s). After homogenization of the aerosol sample during the dwell-time, the second valve 155 is opened while keeping the first valve 150 closed. The intrinsic suction of a mass spectrometer allowed injection of aerosol sample from the chamber into the mass spectrometer for mass analysis.

In order to achieve the sufficient suction capability of the chamber 100 with a small volume of 120 ml, the pump 110 was selected to meet the specifications described in Table 1. For filling the chamber of 125 mL volume, a 30 s of plume collection would require 0.25 L/min minimum flow rate of the pump. Example parameters for the pump 110 are shown in FIG. 2C. Example parameters for the pump 110 are shown in FIG. 2C. It will be understood that suitable parameters for the pump will depend on various factors, such as the rate of generation of the aerosol plume and the volume of the chamber 100.

In an alternative example implementation of the system shown in FIG. 2A, the pump 110 may be operated in a bidirectional configuration. The pump 110 is initially employed to evacuate the chamber 100, as described above, followed by opening the first valve 150 to collect the aerosol sample in the chamber 100. The first valve 150 is then closed, the second valve 155 is opened, and the pump 110 is controlled to reverse its flow direction to push air from atmosphere into the chamber 110, resulting in the injection of the collected aerosol sample into the mass spectrometer 130 by the combination of its own suction and the flow created by the pump 110. FIG. 2D provides the maximum flow rate and type of different pumps that are commercially available and which were found to be suitable for use with the 120 ml chamber of the present example implementation. FIG. 2E provides a diagram illustrating the timing of the operations for this example embodiment.

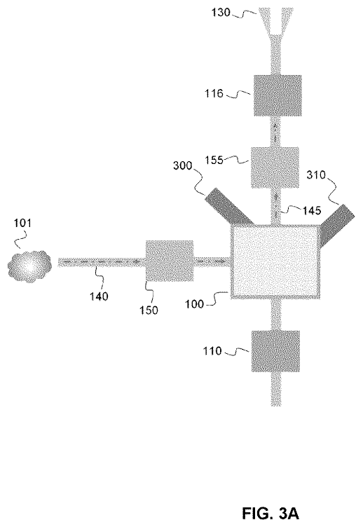

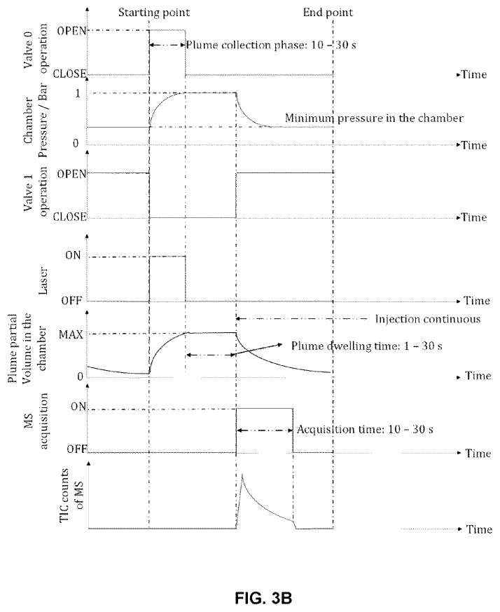

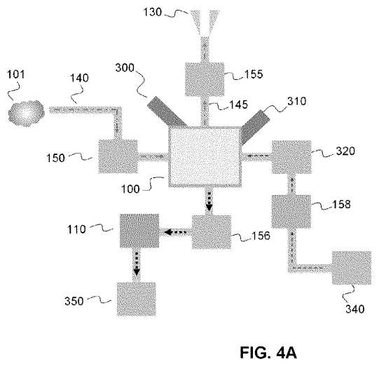

FIG. 3A illustrates another example embodiment that employs two pumps 110 and 118, with a first pump 110 being employed for collection of the aerosol sample, and a second pump 118 being employed for injection of the aerosol plume into the mass spectrometer. FIG. 3B is a timing diagram that illustrates the sequence of operations and the control of the two pumps. The first pump 110 is absent from operation during injection of the collected aerosol sample into the analysis device.

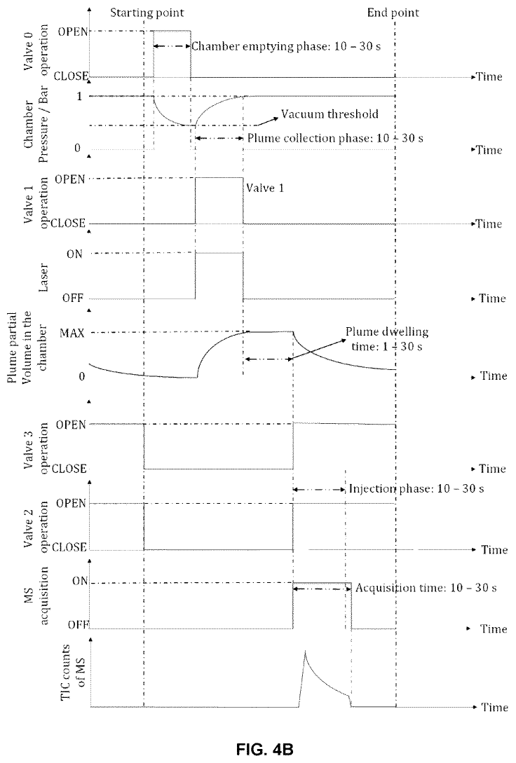

FIG. 4A shows an alternative embodiment using four valves 150, 155, 156 and 158, a pressure sensor 310, a mass-flow controller 320 and a pump 110. The pressure sensor 310 is capable of monitoring the pressure inside the chamber 100, thereby providing a feedback signal indicative of the pressure within the chamber, which can be employed to control the opening and closing of the valves. FIG. 4B shows a timing diagram illustrating an example method of operation of the system shown in FIG. 4A.

Prior to the generation of the aerosol plume 101, the residual contents of the chamber 100 may be optionally removed. The first, second and fourth valves (150, 155 and 158) are closed and the third valve 156 is opened, and the first pump 110 is operated to evacuate the chamber 100, to an exhaust port 350, for example, an exhaust-line of the facility. The pressure sensor 310 may be employed to monitor the reduction of pressure in the chamber 100 to determine when it has been sufficiently evacuated (e.g., when a threshold level of vacuum has been reached within the chamber), after which the third valve 156 is closed. In some example implementations, the chamber 100 may be evacuated down to a pressure of 500 mBar (it was found that the time duration needed to achieve this pressure, for the specific system employed by the inventors, was between 10 s and 30 s).

During or after generation of the aerosol plume 101, the first valve 150 is opened and the aerosol sample is collected into the chamber 100 as a consequence of the suction generated by the partial vacuum within the chamber 100. The chamber 100 is filled with the aerosol sample until the pressure within the chamber is equilibrated with the external pressure (i.e., the pressure in the vicinity of the generation of the aerosol plume). It was found that for a typical 1 m long tube having an inner diameter of 1/16″, the calculated initial flow rate of the aerosol sample, based on the pump employed in the example implementation, was found to be approximately 2 L/min; however, as the chamber 100 fills up and the pressure increases, the pressure difference across the collection tube diminishes and the flow rate reduces. It was found that it takes approximately 10 s to 30 s to fill the chamber 100 up to a pressure of 95% of atmospheric pressure, as monitored by with pressure sensor 310.

After having determined that the pressure within the chamber 100 has increased to a sufficiently high value (e.g., a pre-determined threshold, such as 0.95 bar), the first valve 150 is closed. The collected aerosol sample may be retained within the chamber 100 for a dwell time (residence time), such as, for example, 0 to 30 s, to facilitate homogenization by diffusion. As shown in the figure, a heater 300 may be employed to heat the walls of the chamber, which may be beneficial in maintaining the aerosol sample in a desolvated state, and to reduce condensation on the walls of the chamber.

After the predefined dwell time has elapsed, the second and third valves 155 and 158 are opened. The mass flow controller 320 prescribes a flow rate of an inert gas (e.g., nitrogen gas) from an inert gas source 340 through the fourth valve 156. The opening of the second valve 155 allows the plume to be guided towards the inlet of the mass spectrometer. The flow rate of the mass-flow controller can be adjusted to provide a suitable flow rate for a given mass spectrometer (e.g., to approximately match the suction flow rate of the mass spectrometer) or another analytic device. The inventors have found that in some experimental configurations, a suitable flow rate for the mass flow controller lies within the range of 0-2 L/min. In this case, the plume is injected into the mass spectrometer within 4-5 s. It has been found that in some experimental configurations, the mass flow rate between 0.05 L/min to 1.8 L/min, the time duration of injection of the plume into the inlet of the mass spectrometer could be extended up to 150 s. It will be understood that if the pump is capable of holding a vacuum while in off state, the third valve 156 can be absent from the system. Likewise, if the mass flow controller is capable of holding a vacuum while in off state, the fourth valve 158 can be absent from the system.

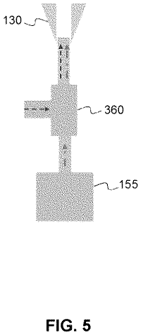

In some example implementations, as illustrated in FIG. 5, the second fluidic conduit 145 may include a T-junction 360 that is provided to allow balancing of the difference between the flow capabilities of the pump 110 (and/or a second pump 118) and the suction capabilities of the mass spectrometer by permitting air to flow through a port of the T-junction 360. In this example embodiment, the outward flow rate of the chamber 100 using the one or more pumps (and/or a mass flow controller) do not need to match with the inlet suction capability of the mass spectrometer and the injection time can be tailored to a value independent of the inlet flow rate of the mass spectrometer. The differential flow rate is compensated by intake of air from the third port of the T-junction 360. This configuration leads to dilution of the plume, but potentially provides stable mass flow rate into the mass spectrometer for a longer period for achieving high signal-to-noise, and nearly-steady rate of plume injection. This modification may be applied to any of the example embodiments disclosed herein.

As described above, in some example implementations, the aerosol plume may be generated using ablation via picosecond laser pulses (PIRL). PIRL laser pulses may be employed that are sufficiently short to drive ablation faster than the timescales associated with thermal and acoustic transport, thus avoiding damage due to heat and shock wave formation, while also being sufficiently long to avoid the ionizing radiation effects of plasma formation.

PIRL pulses may be provided with a wavelength selected such that absorption of the laser pulses by tissue is predominantly due to excitation of vibrational modes of one or more constituents of the tissue, such as water. Suitable wavelength ranges for PIRL laser pulses therefore include 2.7-3.3 μm, 5.9-6.1 μm and 1.8-2.0 μm. Future developments in high energy and short pulsed laser sources will enable PIRL cutting by targeting vibrational absorption in target molecules between 2-20 μm.

For example, the PIRL laser pulse wavelength may be selected to overlap with, or reside proximal to, a strong peak in the vibrational spectrum of a constituent of the tissue, such as the OH-stretch region of H₂O. Such vibrational modes quickly absorb the electromagnetic radiation and may effectively localize optical energy to micron scale deep sections of the exposed tissue. In the case of water, maximum absorption for vibrational modes occurs between about 2.7-3.33 μm, where broad peak in the absorption spectrum corresponds to the OH-stretching vibrational modes of liquid water molecules. The spectrum also shows the resonance conditions between the OH-stretch and other vibrational modes such as the OH bend and Intermolecular modes. Other absorption peaks, for example, at approximately 1.9 μm or approximately 6 μm, may alternatively be employed.

PIRL pulses may be generated and delivered such that when a given volume of tissue is irradiated, the pulse duration is shorter than (i) the time duration required for thermal diffusion out of the laser-irradiated volume of tissue, and (i) the time duration required for a thermally driven expansion of the laser-irradiated volume of tissue. The skilled artisan will be able to determine a suitable pulse duration for PIRL pulses for a given pulse wavelength and absorption depth in tissue. In general, for a given PIRL laser pulse wavelength that is selected according to the aforementioned criterion (absorption of the laser pulses by tissue is predominantly due to excitation of vibrational modes of one or more constituents of the tissue), the known properties of the tissue, such as the absorption depth of the laser pulses, thermal diffusion constant, and the speed of sound, may be employed to calculate a suitable PIRL pulse duration that satisfies criteria (i) and (ii) above. Alternatively or additionally, experiments may be performed to determine a suitable laser pulse duration that satisfies criteria (i) and (ii).

For example, in the case of ablating tissue with a laser wavelength of 3 μm, for which the absorption depth is approximately 1 μm, the maximum pulse duration can be calculated based on the ratio of absorption depth to speed of sound, 1730 m/sec. Or t=a/v=10⁻⁶ m/1.730×10³ m/s=5.78×10⁻¹⁰ sec, approximately 600 ps (e.g., see Duck, F. A., Physical Properties of Tissue, Academic Press, London, 1990, and Duck, F. A., Propagation of Sound Through Tissue, in “The Safe Use of Ultrasound in Medical Diagnosis”, ter Haar G and Duck, F. A, Eds., British Institute of Radiology, London, 2000, pp. 4-15).

Different tissue will have different absorption depth at a given wavelength, example bone, brain and skin. Around the OH-stretching band, the absorption of the tissue is dominated by the water content. For skin, the water content can vary between the surface and deeper layers. In general, the absorption depth will be longer than pure water. At a wavelength of 2.95 μm, the absorption depth of pure water is close to 0.7 μm, and given the variance in the high concentration of water in the skin, along with other OH-stretching modes in the tissue, the absorption depth of skin is thus approximately 1-2 μm at this wavelength. If the wavelength of the laser is shifted, e.g., to a wavelength of 2.75 μm, then the absorption depth of the light increases by a factor of about 3 according to the change in the absorption spectrum of the OH-stretch. (see, for example, Diaci, J., J. Laser and Health Acad. 2012, 1-13 (2012).

In another example in which tissue is ablated using a laser wavelength of 6 μm, for which the absorption depth is approximately 100 μm, the pulse duration may be chosen as shorter than 100 μm/1.753×10³⁼⁵⁷ ns.

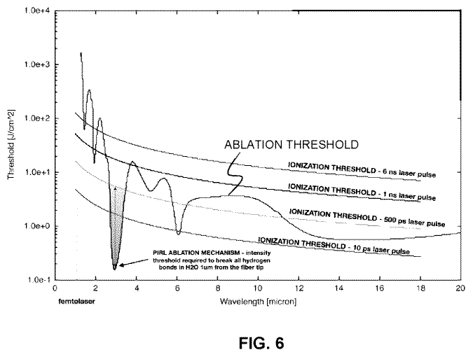

The pulse duration and pulse fluence may also selected such that a peak pulse intensity is below a threshold for ionization-driven ablation to occur within the laser-irradiated volume of tissue. For example, for a given pulse duration, a suitable upper limit of the pulse fluence may be determined to avoid the threshold for ionization-driven ablation. In the example case of human skin tissue, at a laser wavelength 3 μm, the maximum fluence values for avoiding ionization-driven ablation, for pulse durations of 10 ps, 500 ps, and 1 ns, are approximately 1.5 J/cm², 5.5 J/cm², and 17 J/cm², respectively, as shown in FIG. 6.

Furthermore, in order to achieve PIRL-based ablation of tissue for laser pulses that satisfy the preceding criteria involving wavelength, pulse duration and pulse fluence, the laser pulses should be provided with a sufficient pulse fluence to achieve a threshold energy density for PIRL ablation, as shown, for example, by the ablation threshold identified in FIG. 6. For example, the pulse fluence that is delivered to the tissue should be sufficiently high to that the energy deposited in the irradiated volume is sufficient to heat the contents of the volume up to its vaporization temperature including the enthalpy of vaporization.

For example, if the beam is focused to 200 μm (or a 200 μm fiber is used in contact) and ablates a volume of ˜1 μm deep×π(100 μm)² the mass of the ablated volume is 3.1×10⁻⁸ g in the case of water and 3.4×10⁻⁸ g in the case of skin (which has a density of 1.15 g/cm³). The energy required to raise the temperature of this volume of water from 20 to 100° C. and then vaporize the volume is approximately 80 μJ of energy, which corresponds to a fluence of 0.25 J/cm² for a 200 μm spot. This fluence defines the threshold for impulsive heat deposition to drive the phase transition without loss due to acoustic transport or thermal diffusion out of the excited zone. Higher degrees of superheating above this threshold leads to faster rates of vaporization with the excess energy going into translation energy or high exit velocity of the plume. To ensure the ensuing ablation process occurs in this limit, for highly scattering medium such as tissue which effectively decreases the incident intensity, typical excitation conditions used are 1 J/cm². The determination of a sufficient fluence for PIRL ablation can be made experimentally by varying the applied fluence, examining the resulting tissue ablation, and selecting an applied fluence value that provides a sufficient amount or degree of ablation.

The preceding conditions for generating and delivering PIRL laser pulses can be achieved using a wide variety of different laser systems. Non-limiting examples of suitable laser systems include a near-IR pumped optical parametric amplifier (e.g., emitting pulses with a duration in the hundreds of ps, such as 500 ps) tuned to a wavelength of approximately 2.95 μm, operating, for example, between 1-10 KHz with a pulse fluence greater than 0.5 mJ/pulse, delivered on target, for example, through a sapphire fiber optic (e.g., having a core diameter of 200 μm); and a Cr:ZnSe gain-switched laser, emitting ns pulses (e.g., 1.5 ns), tuned to a wavelength of approximately 2.7 μm, operating, for example, between 1-10 kHz, with a pulse fluence greater than >1 mJ/pulse, e.g., focused onto the surface by an imaging system.

Moreover, it will be understood that the laser pulses that are delivered to the tissue surface may be delivered via an optical waveguide, such as an optical fiber tip, or via free space (e.g., focused by a focusing element through a free-space path onto the tissue).

### EXAMPLES

The following examples are presented to enable those skilled in the art to understand and to practice embodiments of the present disclosure. They should not be considered as a limitation on the scope of the disclosure, but merely as being illustrative and representative thereof.

### Example 1: Example System Employing Syringe Pump and Picosecond Laser Ablation for Aerosol Plume Generation

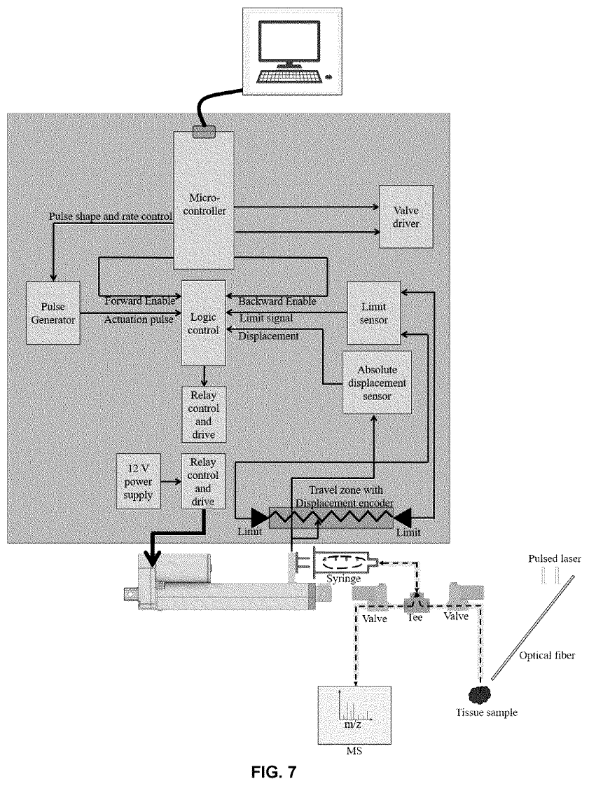

Referring now to FIG. 7, an example implementation is shown of a control system for controlling the example apparatus shown in FIG. 1C. A surgical syringe of 50 mL volume is used to store an aerosol sample from an aerosol plume generated by a pulsed laser. The inlet of the syringe is branched into one inlet and one outlet port, each consisting of a solenoid valve. The inlet tube is hand-held within 2 mm of the tissue sample excited by the PIRL and the outlet tube is exposed to within 5 mm of the inlet of the mass-spectrometer. A linear actuator of 750 N load-capacity is used to extract the plume into the syringe while the valve at the inlet port is actuated. After storing and homogenizing the plume in the syringe for 10 sec., the valve at the outlet port is actuated and the syringe is evacuated close to the inlet of the mass-spectrometer in another 10 sec. Chromatograms of the analyzed masses from the mass-spectrometer clearly show stable charge injection as opposed to highly heterogeneous injection observed by directly collecting the plume into the mass-spectrometer from the tissue sample.

In another embodiment, multiple syringes are used a controlled sequence, to provide continuous operation of the plume collection and injection method.

The plume stabilization is achieved by collecting the aerosol sample from the laser-induced aerosol plume in a surgical syringe of 50 mL volume at a constant flow rate and then ejecting the collected plume to the inlet of the mass-spectrometer at a constant flow rate. A high flow rate (up to 10 mL/sec), large stroke (up to 100 mm), syringe pump instrument is implemented and integrated in a sampling stage. A linear actuator, capable of 8″ bidirectional travel and producing up to 750 N force, is used for the high flow rate action of the syringe pump. For backward (collecting plume) and forward (ejecting plume) motion of the piston, a high-power (up to 100 W) bipolar relay-mechanism is implemented using a 12 V, 7 A power supply and single-pole-double-throw (SPDT) relays. The speed of motion in either direction is controlled by applying the 12 V actuation in form of pulses with a controlled repetition rate (up to 30 Hz) and duty cycle (up to 30%). The piston is anchored in the actuator rod and the syringe is mounted and aligned on a base-stage. Two electrically actuated solenoid valves are used at the syringe-inlet using a T-junction. When the linear actuator is enabled to collect plume, the first valve is opened while the second remains closed. Following collection of the aerosol sample, the linear actuator is enabled for ejecting the plume into the mass spectrometer-inlet and at this mode, the second valve is opened while the first is closed. The volume of plume and volume rate are monitored using an electrical encoder implemented by a sliding potentiometer mounted and aligned on the printed circuit board (PCB) developed for the entire electronics. The slider of the potentiometer is fixed at the actuator rod and its position is encoded by the analog voltage at the wiper terminal of the potentiometer. Two adjustable and spring-loaded limit switches are implemented on the PCB to stop the motion of the piston when the piston reaches end of the syringe in both directions.

The flow rate control is achieved by applying 12 V pulses to the actuator terminals with configurable pulse repetition rate and duty cycle. A RC timer circuit with digital potentiometers are used for generating the desired repetition rate and duty cycle. The pulse waveforms (0-5 V) are then used for driving high-power electromechanical single-pole-double-throw (SPDT) relays (0-12 V, 5 A) connected to the input terminals of the actuator. For forward and backward movement, the polarity of the high-power pulses is reversed using a pair of such electromechanical relays.

The displacement encoder is implemented using a sliding 100 kΩ potentiometer with its slider attached to the actuator rod, applying a 5 V potential between the two ends of the potentiometer and measuring the potential at the slider-terminal as the actuator moves forward or backward. The forward and backward motion of the actuator are controllable in any of the following modes:

Displacement control: There are two voltage comparators on the PCB where a set potential corresponding to absolute desired displacement is compared with the true displacement measured by the encoder. As the desired displacement is reached, the logic control block stops the pulses applied to the actuator.

Limit control: There are two limit switches at the two ends of the sliding potentiometer whose positions are adjustable using a pair of spring-loaded screws. The switches are normally open and are pulled to 5 V potential. The anchor between the actuator rod and the slider head has two grounded electrodes and come in contact with the limit switches as the limiting displacement is reached. This closes the corresponding limit switch, disabling the pulses applied to the actuator.

In the preferred embodiment of the operation, the limit switch at one end (piston completely inserted) is used as limit control when the syringe ejects the plume to the MS and the desired displacement control is used when the syringe collects plume for a specified volume.

The two valves at the collection phase and ejection phase are controlled by applying a 5 V signal to the corresponding valve for the entire duration when the syringe is either in the collection phase or in the ejection phase. In the preferred embodiment, the corresponding valve is opened 1 sec before starting the actuator and closed 1 sec after the actuator is stopped.

The electronic control and data acquisition is implemented by a microcontroller and using software such as MATLAB. A graphical user interface (GUI) is developed for performing the operation of the system, including communication with the digital output logic control blocks, the pulse generator blocks and for recording analog voltages for displacement monitoring and feedback.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method of performing mass spectrometry on a collected aerosol, the method comprising:
employing an aerosol generating device to generate an aerosol plume from a material;
during and/or after generation of the aerosol plume by the aerosol generating device, collecting, via suction generated by a pump, an aerosol sample into a chamber, such that collection of the aerosol sample is temporally controlled relative to the generation of the aerosol plume, the aerosol sample comprising at least a portion of the aerosol plume;
bringing the chamber into fluidic communication with an inlet of a mass spectrometer; and
injecting the aerosol sample from the chamber to the mass spectrometer.

2. (canceled)

3. The method according to claim 1 wherein a composition of the aerosol plume generated from the material is spatially heterogeneous, and wherein the collection and the injection of the aerosol sample is configured such that during injection of the aerosol sample into the mass spectrometer, a composition of the aerosol sample is substantially homogeneous.

4. The method according to claim 1 further comprising, after collecting the aerosol sample into the chamber, preventing fluid communication between the chamber and an external ambient environment for a dwell time interval before bringing the chamber into fluidic communication with the inlet of the mass spectrometer.

5-11. (canceled)

12. The method according to claim 1 wherein the aerosol plume is generated at least 1 m from the inlet of the mass spectrometer, and wherein an intrinsic intake rate of the mass spectrometer would be insufficient to directly sample the aerosol plume through a conduit extending between the aerosol plume and the inlet of the mass spectrometer.

13-15. (canceled)

16. The method according to claim 1 wherein the pump is controlled to inject of the aerosol sample from the chamber to the mass spectrometer.

17-20. (canceled)

21. The method according to claim 1 wherein the pump is a first pump, the chamber is a first chamber and the aerosol sample is a first aerosol sample, wherein a time duration of generation of the aerosol plume is longer than a time duration of collection of the first aerosol sample by the first pump, and wherein the first aerosol sample comprises a first portion of the aerosol plume, the method further comprising:
during and/or after generation of the aerosol plume by the aerosol generating device, actuating a second pump to collect a second aerosol sample into a second chamber, such that control of the second pump and collection of the second aerosol sample occurs after collection of the first aerosol sample by the first pump, the second aerosol sample comprising a second portion of the aerosol plume;
bringing the second chamber into fluidic communication with the inlet of the mass spectrometer; and
injecting the second aerosol sample from the second chamber to the mass spectrometer.

22-24. (canceled)

25. The method according to claim 1 further comprising, during collection of the aerosol sample, employing a sensor to measure a signal dependent on an amount of collected aerosol, the sensor being in fluid communication with the chamber; and
further comprising controlling the pump for collection of the aerosol sample according to feedback from the sensor, such that the aerosol sample is collected until the signal satisfies pre-selected criteria.

26-28. (canceled)

29. The method according to claim 1 wherein the chamber is in fluid communication with:
an inlet of the pump;
a first fluidic conduit; and
a second fluidic conduit;
wherein the first fluidic conduit comprises a first distal port located proximal to a location of generation of the aerosol plume, and wherein the second fluidic conduit comprises a second distal port located proximal to the inlet of the mass spectrometer, and wherein a first valve is provided to control fluid communication between the chamber and the first distal port, and wherein a second valve is provided to control fluid communication between the chamber and the second distal port;
wherein, prior to collection of the aerosol sample, the first valve and the second valve are closed and the pump is operated to generate a partial vacuum in the chamber; and
wherein collection of the aerosol sample from the aerosol plume is performed while operating the pump with the first valve in an open state and the second valve in a closed state.

30-49. (canceled)

50. The method according to claim 1 wherein injection of the aerosol sample into the mass spectrometer is performed in the absence of collection on a membrane.

51. (canceled)

52. (canceled)

53. A method of performing analysis of a collected aerosol, the method comprising:
employing an aerosol generating device to generate an aerosol plume from a material;
during and/or after generation of the aerosol plume by the aerosol generating device, collecting, via suction generated by a pump, an aerosol sample into a chamber, such that collection of the aerosol sample is temporally controlled relative to the generation of the aerosol plume, the aerosol sample comprising at least a portion of the aerosol plume;
bringing the chamber into fluidic communication with an inlet of an analysis device; and
injecting the aerosol sample from the chamber to the analysis device.

54. A system for performing mass spectrometry on a collected aerosol, the system comprising:
an aerosol generating device operable for generating an aerosol plume;
a mass spectrometer;
a chamber, wherein the chamber is in fluidic communication with a first fluidic conduit and a second fluidic conduit, wherein the first fluidic conduit comprises a first distal port located proximal to a location of generation of the aerosol plume, and wherein the second fluidic conduit comprises a second distal port located proximal to an inlet of the mass spectrometer, and wherein a first valve is provided to control fluid communication between the chamber and the distal port, and wherein a second valve is provided to control fluid communication between the chamber and the second distal port; and
a pump operable to generate suction suitable for collecting an aerosol sample from the aerosol plume into the chamber; and
control and processing circuitry operably connected to the pump, the first valve and the second valve, the control and processing circuitry comprising at least one processor and memory, the memory comprising instructions executable by the processor for performing operations comprising:
during and/or after generation of the aerosol plume by the aerosol generating device, opening the first valve and employing suction generated by the pump to collect the aerosol sample into the chamber, such that collection of the aerosol sample is temporally controlled relative to generation of the aerosol plume, the aerosol sample comprising at least a portion of the aerosol plume;
closing the first valve and opening the second valve, thereby bringing the chamber into fluidic communication with the inlet of the mass spectrometer, thereby facilitating injection of the aerosol sample from the chamber to the mass spectrometer.

55. (canceled)

56. (canceled)

57. The system according to claim 54 wherein the mass spectrometer is a slow-scanning mass spectrometer configured to scan a predetermined mass range during an acquisition time exceeding 1 ms.

58. (canceled)

59. The system according to claim 54 wherein the pump is a first pump, the chamber is a first chamber and the aerosol sample is a first aerosol sample, wherein a time duration of generation of the aerosol plume is longer than a time duration of collection of the first aerosol sample by the first pump, and wherein the first aerosol sample comprises a first portion of the aerosol plume, wherein the control and processing circuitry is further configured to control operations comprising:
during and/or after generation of the aerosol plume by the aerosol generating device, actuating a second pump to collect a second aerosol sample into a second chamber, such that control of the second pump and collection of the second aerosol sample occurs after collection of the first aerosol sample by the first pump, the second aerosol sample comprising a second portion of the aerosol plume;
bringing the second chamber into fluidic communication with the inlet of the mass spectrometer; and
injecting the second aerosol sample from the second chamber to the mass spectrometer.

60. (canceled)

61. (canceled)

62. The system according to claim 54 further comprising a heater.

63-66. (canceled)

67. The system according to claim 54 wherein the chamber is in fluid communication with an inlet of the pump and wherein the control and processing circuitry is further configured to control the first valve and the second valve such that:
prior to collection of the aerosol sample, the first valve and the second valve are closed and the pump is operated to generate a partial vacuum in the chamber; and
collection of the aerosol sample from the aerosol plume is performed while operating the pump with the first valve in an open state and the second valve in a closed state.

68. The system according to claim 67 wherein injection of the aerosol sample into the mass spectrometer is facilitated, at least in part, by intrinsic suction of the mass spectrometer with the second valve in an open state.

69. The system according to claim 67 wherein the control and processing circuitry is further configured to control the first valve and the second valve such that, after collecting the aerosol sample into the chamber, the first valve and the second valve are closed to prevent fluid communication between the chamber and an external ambient environment for a dwell time interval.

70-74. (canceled)

75. The system according to claim 67 wherein the second fluidic conduit comprises a T-junction for facilitating the introduction of air with the aerosol sample during injection of the aerosol sample.

76. The system according to claim 67 further comprising a mass flow controller, the mass flow controller having an inlet in communication with a source of inert gas source and an outlet in fluid communication with the chamber;
wherein the mass flow controller is controlled by the control and processing circuitry to inject the inert gas into the chamber at a controlled flow rate during injection of the aerosol sample.

77-81. (canceled)

82. The system according to claim 54 wherein the aerosol generating device is configured to generate the aerosol according to a modality selected from the group consisting of diathermy, ultrasonic aspiration, focused ultrasound, radiofrequency ablation, nebulization, laser desorption, laser ablation and photoacoustic drilling.

83. (canceled)
